(19) United States
(12) Patent Application Publication
(10) Pub. No.: US 2024/0310709 A1
(43) Pub. Date: Sep. 19, 2024

(54) LASER SAFETY CIRCUITRY FOR INTRAORAL SCANNERS

(71) Applicant: Align Technology, Inc., San Jose, CA (US)

(72) Inventors: Danny Seidner, Herzeliya (IL); Yevgeny Faingold, Kiryat Gat (IL); Moshe Alboher, Tsoran (IL); Alex Reajev, Holon (IL); Gilad Furst, Or Yehuda (IL)

(21) Appl. No.: 18/603,790

(22) Filed: Mar. 13, 2024

Related U.S. Application Data
(60) Provisional application No. 63/452,982, filed on Mar. 17, 2023.

(51) Int. Cl. G03B 21/20; G02B 26/10

(52) U.S. Cl. CPC G03B 21/2046; G02B 26/101; G03B 21/2033

(57) ABSTRACT

Embodiments relate to an intraoral scanner that includes one or more light projectors to emit coherent light, the one or more light projectors including a laser diode. Safety circuitry is coupled to the laser diode, the safety circuitry configured to detect a power level of the laser diode and disable the laser diode responsive to detecting that the power level satisfies a threshold power level.

### REFERENCE TO RELATED APPLICATION

This application claims the benefit of U.S. Provisional Patent Application No. 63/452,873, filed Mar. 17, 2023, the entirety of which is incorporated herein by reference.

### TECHNICAL FIELD

Embodiments of the present disclosure relate to the field of dentistry and, in particular, to laser safety circuitry for intraoral scanners.

### BACKGROUND

In prosthodontic procedures designed to implant a dental prosthesis in the oral cavity, the dental site at which the prosthesis is to be implanted in many cases should be measured accurately and studied carefully, so that a prosthesis such as a crown, denture or bridge, for example, can be properly designed and dimensioned to fit in place. A good fit enables mechanical stresses to be properly transmitted between the prosthesis and the jaw, and to prevent infection of the gums via the interface between the prosthesis and the dental site, for example.

Some procedures also call for removable prosthetics to be fabricated to replace one or more missing teeth, such as a partial or full denture, in which case the surface contours of the areas where the teeth are missing need to be reproduced accurately so that the resulting prosthetic fits over the edentulous region with even pressure on the soft tissues. In some practices, the dental site is prepared by a dental practitioner, and a positive physical model of the dental site is constructed using known methods.

Alternatively, the dental site may be scanned to provide 3D data of the dental site. Certain intraoral scanners employ multiple light projectors (or light sources) that are used in conjunction with cameras to obtain such 3D data. Such intraoral scanners employ drivers (such as current drivers), each to drive one or more of the light projectors. Some of the light projectors are particular laser diodes that improve the accuracy of 3D imagining of the oral cavity. Some laser diodes, however, are at risk of harming other parts of a human patients, particularly the eye if those types of laser diodes are irradiated too long or at too high of a current.

### SUMMARY

In a first implementation, an intraoral scanner comprises one or more light projectors to emit coherent light, the one or more light projectors includes a laser diode. The intraoral scanner further includes safety circuitry coupled to the laser diode. The safety circuitry configured to detect a power level of the laser diode and disable the laser diode responsive to detecting that the power level satisfies a threshold power level.

In a related implementation, a method includes causing one or more light projectors of an intraoral scanner to emit coherent light, where the one or more light projectors comprise a laser diode. The method further Includes detecting, by a safety circuitry, a power level of the laser diode. The method further includes disabling, by the safety circuitry, the laser diode responsive to detecting that the power level satisfies a threshold power level.

### BRIEF DESCRIPTION OF THE DRAWINGS

Embodiments of the present disclosure are illustrated by way of example, and not by way of limitation, in the figures of the accompanying drawings.

FIG. 1 illustrates one embodiment of a system for performing intraoral scanning and/or generating a virtual three-dimensional model of a dental site.

FIG. 2A is a schematic illustration of a handheld intraoral scanner with cameras disposed within a probe at a distal end of the intraoral scanner, in accordance with some applications of the present disclosure.

FIGS. 2B-2C comprise schematic illustrations of positioning configurations for cameras and structured light projectors of an intraoral scanner, in accordance with some applications of the present disclosure.

FIG. 2D is a chart depicting a plurality of different configurations for the position of structured light projectors and cameras in a probe of an intraoral scanner, in accordance with some applications of the present disclosure.

FIG. 3 is a schematic block diagram of an intraoral scanner, in accordance with some applications of the present disclosure.

FIG. 4 is a flow chart for a method of monitoring and ensuring safe operations of a plurality of light projectors, in accordance with embodiments of the present disclosure.

FIG. 5A is driver circuit for driving a laser diode and integrated safety circuitry, in accordance with some applications of the present disclosure.

FIG. 5B is a schematic diagram of the inputs and outputs of an exemplary current driver useable in the driver circuits referred to herein, in accordance with some applications of the present disclosure.

FIG. 6 is a schematic block diagram of an intraoral scanner illustrating how a processor interacts with a driver circuit and an integrated safety circuitry to ensure safe operation of laser diodes, in accordance with some applications of the present disclosure.

FIG. 7A is an exemplary row enable voltage shift circuit with circuitry that acts on a laser alert signal to disable load switches, in accordance with some applications of the present disclosure.

FIG. 7B is an exemplary overdrive voltage shift circuit with circuitry that acts on a laser alert signal to disconnect overdrive signals, in accordance with some applications of the present disclosure.

FIG. 7C is an exemplary driver enable voltage shift circuit with circuitry that acts on a laser alert signal to disconnect driver enable signals, in accordance with some applications of the present disclosure.

FIG. 8 is a schematic diagram of a driver circuit, which drives two laser diodes using a single driver, with integrated safety circuitry, in accordance with some applications of the present disclosure.

FIG. 9 is a schematic diagram of a driver circuit with safety circuitry that senses current going into multiple current drivers that drive sets of laser diodes, in accordance with some applications of the present disclosure.

FIG. 10 is a schematic diagram of a driver circuit with safety circuitry that sense an output current of a current driver when that current driver is driving a particular laser diode of multiple laser diodes, in accordance with some applications of the present disclosure.

FIG. 11 is a schematic diagram of a driver circuit with safety circuitry that senses an output current of a current driver that drives more than one laser diode, in accordance with some applications of the present disclosure.

FIG. 12 is a simplified schematic diagram of a driver circuit illustrating different exemplary locations where a sense resistor can be positioned to which is coupled safety circuitry as discussed herein, in accordance with some applications of the present disclosure.

FIG. 13 is a flow chart of a method for monitoring light projectors of an intraoral scanner and disabling a laser diode in response to detecting current passing through the laser diode exceeds a threshold current, in accordance with some applications of the present disclosure.

FIG. 14 illustrates a diagrammatic representation of a machine in the example form of a computing device within which a set of instructions, for causing the machine to perform any one or more of the methodologies discussed herein, may be executed.

### DETAILED DESCRIPTION

Described herein are methods and systems that employ laser safety circuitry as well as light projection safety control logic to ensure light projectors remain safe to human patients and operators during operation. Of the light projectors discussed herein, blue laser diodes in particular are to be closely monitored and controlled to prevent unsafe operation that may harm the human eye. Other types of light projectors (e.g., light sources) may also include certain risk factors and thus may also be monitored and controlled to ensure safe operation. Because there are several light projectors that are sequenced with frames of cameras of an intraoral scanner, the timing of the monitoring and control of the light projectors is further complicated because the pulse duration and current restrictions vary across different light projectors, e.g., blue laser diodes, green laser diodes, white light-emitting diodes (LEDs), and near-infrared LEDs. At least some of these different light projectors can be driven by the same circuitry, to include current drivers, so switching between activations of different light projector types is in real time.

In some embodiments, control logic of the intraoral scanner sequentially activates a set of light projectors in connection with timed capture of image frames of one or more cameras of the intraoral scanner. The control logic can be, for example, a Field Programmable Gate Array (FPGA), Application-Specific Integrated Circuit (ASIC), a processing unit (such as a central processing unit combined with a memory control unit), or other such programmed hardware, circuitry, dedicated logic, programmable logic, microcode, integrated circuit, or combination thereof. Further, to activate the set of light projectors in various embodiments, the control logic can control current drivers to power the light projectors on and off for certain pulse periods that are timed with image frames captured by corresponding cameras, e.g., tens to hundreds of frames per second. In these embodiments, the control logic retrieves, from memory, pulse length values that limit durations of pulses of one or more light projectors of the set of light projectors and tracks, using one or more counters, pulse lengths of the one or more light projectors during operational scanning. In one or more embodiments, responsive to detecting the pulse length of a pulse from a light projector of the set of light projectors satisfies a corresponding pulse length value, the control logic triggers a processor of the intraoral scanner to enter a fatal error state that causes the intraoral scanner to become deactivated.

In various embodiments, the light projectors emit coherent light. At least one of the light projectors may be a laser diode, e.g., a blue laser diode or a green laser diode. In these embodiments, the safety circuitry may be coupled to the laser diode and safety circuitry configured to detect a power level of the laser diode. The safety circuit can then disable the laser diode responsive to detecting that the power level satisfies a threshold power level. The safety circuitry can be designed in various ways in order to cause the laser diode to be disabled, which at least in part, depends on how many light projectors are being driven by a current driver that is being monitored, which will be described in detail.

In at least one embodiment, an intraoral scanner includes a set of drivers, each configured to drive a laser diode of a set of laser diodes, where each driver of the set of drivers is to receive a current level signal and is coupled to an enable switch. A sense resistor is coupled within an input current line of the set of drivers to sense current being consumed by the set of drivers at any given time, although not all the laser diodes may be activated at the same time. In these embodiments, the intraoral scanner further includes an analog-to-digital converter (ADC) coupled to the sense resistor. In embodiments, the ADC monitors, through the sense resistor, an input current to the set of drivers. The ADC may further compare the input current to a threshold current. In response to the input current satisfying the threshold current, and activate an alert interrupt signal that causes each enable switch to be turned off.

In alternative embodiments, a sense resistor is coupled inline within an output line of each respective driver of the set of drivers. In these embodiments, an ADC is coupled to a first sense resistor of the sense resistors, the first sense resistor being coupled to a first laser diode of the set of laser diodes. In one or more embodiments, the ADC monitors, through the first sense resistor, a first output current from a driver of the set of drivers. In these embodiments, the ADC compares the first output current to a threshold current and, in response to the first output current satisfying the threshold current, activates an alert interrupt signal. The alert interrupt signal can, for example, cause each enable switch to be turned off. The alert interrupt signal can also inform a processor of the intraoral scanner as a sort of alarm, which when confirmed, the processor can disable the intraoral scanner until a technician can arrive and perform diagnostics on the intraoral scanner, fix any issue causing the current overage (or other error discussed herein), and clear any fatal error state.

Various embodiments are described herein. It should be understood that these various embodiments may be implemented as stand-alone solutions and/or may be combined. Accordingly, references to an embodiment, or one embodiment, may refer to the same embodiment and/or to different embodiments. Some embodiments are discussed herein with reference to intraoral scans and intraoral images. However, it should be understood that embodiments described with reference to intraoral scans also apply to lab scans or model/impression scans. A lab scan or model/impression scan may include one or more images of a dental site or of a model or impression of a dental site, which may or may not include height maps, and which may or may not include intraoral two-dimensional (2D) images (e.g., 2D color images). The disclosed intraoral scanner may, therefore, be configured to perform scans in any of these applications or settings.

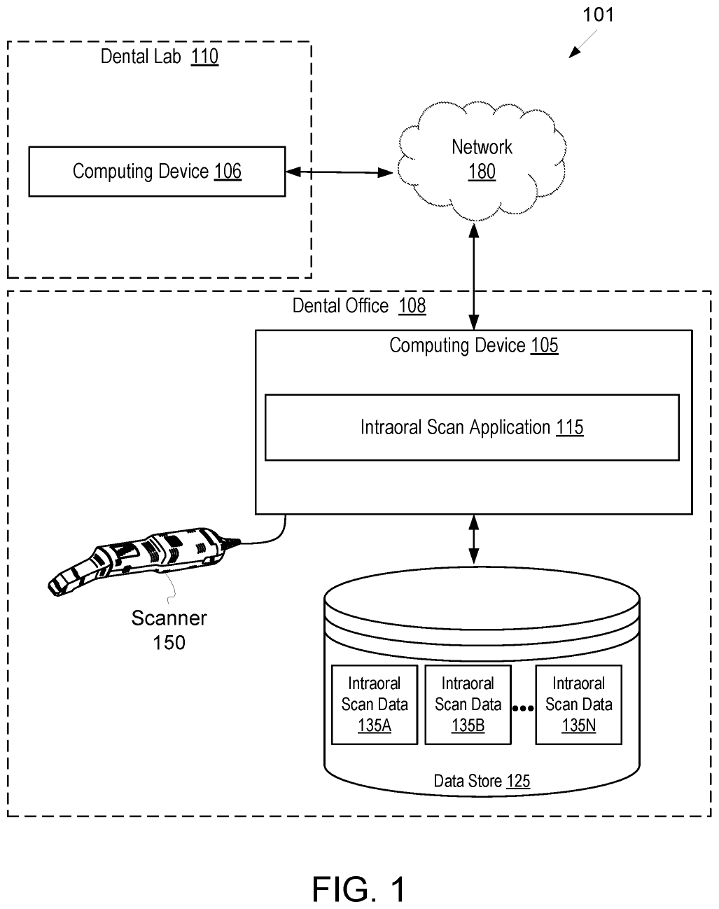

FIG. 1 illustrates one embodiment of a system 101 for performing intraoral scanning and/or generating a three-dimensional (3D) surface and/or a virtual three-dimensional model of a dental site. System 101 includes a dental office 108 and optionally one or more dental lab 110. The dental office 108 and the dental lab 110 each include a computing device 105, 106, where the computing devices 105, 106 may be connected to one another via a network 180. The network 180 may be a local area network (LAN), a public wide area network (WAN) (e.g., the Internet), a private WAN (e.g., an intranet), or a combination thereof.

Computing device 105 may be coupled to one or more intraoral scanner 150 (also referred to as a scanner) and/or a data store 125 via a wired or wireless connection. In one embodiment, multiple scanners 150 in dental office 108 wirelessly connect to computing device 105. In one embodiment, scanner 150 is wirelessly connected (or wired) to computing device 105 via a direct wireless connection. In one embodiment, scanner 150 is wirelessly connected to computing device 105 via a wireless network. In one embodiment, the wireless network is a Wi-Fi network. In one embodiment, the wireless network is a Bluetooth network, a Zigbee network, or some other wireless network. In one embodiment, the wireless network is a wireless mesh network, examples of which include a Wi-Fi mesh network, a Zigbee mesh network, and so on. In an example, computing device 105 may be physically connected to one or more wireless access points and/or wireless routers (e.g., Wi-Fi access points/routers). Intraoral scanner 150 may include a wireless module such as a Wi-Fi module, and via the wireless module may join the wireless network via the wireless access point/router.

Computing device 106 may also be connected to a data store (not shown). The data stores may be local data stores and/or remote data stores. Computing device 105 and computing device 106 may each include one or more processing devices, memory, secondary storage, one or more input devices (e.g., such as a keyboard, mouse, tablet, touchscreen, microphone, camera, and so on), one or more output devices (e.g., a display, printer, touchscreen, speakers, etc.), and/or other hardware components.

In embodiments, scanner 150 includes an inertial measurement unit (IMU). The IMU may include an accelerometer, a gyroscope, a magnetometer, a pressure sensor and/or other sensor. For example, scanner 150 may include one or more micro-electromechanical system (MEMS) IMU. The IMU may generate inertial measurement data (also referred to as movement data), including acceleration data, rotation data, and so on.

Computing device 105 and/or data store 125 may be located at dental office 108 (as shown), at dental lab 110, or at one or more other locations such as a server farm that provides a cloud computing service. Computing device 105 and/or data store 125 may connect to components that are at a same or a different location from computing device 105 (e.g., components at a second location that is remote from the dental office 108, such as a server farm that provides a cloud computing service). For example, computing device 105 may be connected to a remote server, where some operations of intraoral scan application 115 are performed on computing device 105 and some operations of intraoral scan application 115 are performed on the remote server.

Some additional computing devices may be physically connected to the computing device 105 via a wired connection. Some additional computing devices may be wirelessly connected to computing device 105 via a wireless connection, which may be a direct wireless connection or a wireless connection via a wireless network. In embodiments, one or more additional computing devices may be mobile computing devices such as laptops, notebook computers, tablet computers, mobile phones, portable game consoles, and so on. In embodiments, one or more additional computing devices may be traditionally stationary computing devices, such as desktop computers, set top boxes, game consoles, and so on. The additional computing devices may act as thin clients to the computing device 105. In one embodiment, the additional computing devices access computing device 105 using remote desktop protocol (RDP). In one embodiment, the additional computing devices access computing device 105 using virtual network control (VNC). Some additional computing devices may be passive clients that do not have control over computing device 105 and that receive a visualization of a user interface of intraoral scan application 115. In one embodiment, one or more additional computing devices may operate in a master mode and computing device 105 may operate in a slave mode.

Intraoral scanner 150 may include a probe (e.g., a handheld probe) for optically capturing three-dimensional structures. The intraoral scanner 150 may be used to perform an intraoral scan of a patient's oral cavity. An intraoral scan application 115 running on computing device 105 may communicate with the scanner 150 to effectuate the intraoral scan. A result of the intraoral scan may be intraoral scan data 135A, 135B through 135N that may include one or more sets of intraoral scans and/or sets of intraoral 2D images. Each intraoral scan may include a 3D image or point cloud that may include depth information (e.g., a height map) of a portion of a dental site. In embodiments, intraoral scans include x, y, and z information.

Intraoral scan data 135A-N may also include color 2D images and/or images of particular wavelengths (e.g., near-infrared (NIR) images, infrared images, ultraviolet images, etc.) of a dental site in embodiments. In embodiments, intraoral scanner 150 alternates between generation of 3D intraoral scans and one or more types of 2D intraoral images (e.g., color images, NIR images, etc.) during scanning. For example, one or more 2D color images may be generated between generation of a fourth and fifth intraoral scan by outputting white light and capturing reflections of the white light using multiple cameras.

Intraoral scanner 150 may include multiple different cameras (e.g., each of which may include one or more image sensors) that generate 2D images (e.g., 2D color images) of different regions of a patient's dental arch concurrently. These 2D images may be stitched together to form a single 2D image representation of a larger field of view that includes a combination of the fields of view of the multiple cameras. Intraoral 2D images may include 2D color images, 2D infrared or near-infrared (NIR) images, and/or 2D images generated under other specific lighting conditions (e.g., 2D ultraviolet images). The 2D images may be used by a user of the intraoral scanner to determine where the scanning face of the intraoral scanner is directed and/or to determine other information about a dental site being scanned.

The scanner 150 may transmit the intraoral scan data 135A, 135B through 135N to the computing device 105. Computing device 105 may store the intraoral scan data 135A-135N in data store 125.

According to an example, a user (e.g., a practitioner) may subject a patient to intraoral scanning. In doing so, the user may apply scanner 150 to one or more patient intraoral locations. The scanning may be divided into one or more segments (also referred to as roles). As an example, the segments may include a lower dental arch of the patient, an upper dental arch of the patient, one or more preparation teeth of the patient (e.g., teeth of the patient to which a dental device such as a crown or other dental prosthetic will be applied), one or more teeth which are contacts of preparation teeth (e.g., teeth not themselves subject to a dental device but which are located next to one or more such teeth or which interface with one or more such teeth upon mouth closure), and/or patient bite (e.g., scanning performed with closure of the patient's mouth with the scan being directed towards an interface area of the patient's upper and lower teeth). Via such scanner application, the scanner 150 may provide intraoral scan data 135A-N to computing device 105. The intraoral scan data 135A-N may be provided in the form of intraoral scan data sets, each of which may include 2D intraoral images (e.g., color 2D images) and/or 3D intraoral scans of particular teeth and/or regions of a dental site. In one embodiment, separate intraoral scan data sets are created for the maxillary arch, for the mandibular arch, for a patient bite, and/or for each preparation tooth. Alternatively, a single large intraoral scan data set is generated (e.g., for a mandibular and/or maxillary arch). Intraoral scans may be provided from the scanner 150 to the computing device 105 in the form of one or more points (e.g., one or more pixels and/or groups of pixels). For instance, the scanner 150 may provide an intraoral scan as one or more point clouds. The intraoral scans may each comprise height information, e.g., a height map that indicates a depth for each pixel.

The manner in which the oral cavity of a patient is to be scanned may depend on the procedure to be applied thereto. For example, if an upper or lower denture is to be created, then a full scan of the mandibular or maxillary edentulous arches may be performed. In contrast, if a bridge is to be created, then just a portion of a total arch may be scanned which includes an edentulous region, the neighboring preparation teeth (e.g., abutment teeth) and the opposing arch and dentition. Alternatively, full scans of upper and/or lower dental arches may be performed if a bridge is to be created.

By way of non-limiting example, dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity (dental site), or a real or virtual model thereof, or directed to the design and preparation of the dental site to receive such a prosthesis. A prosthesis may include any restoration such as crowns, veneers, inlays, onlays, implants and bridges, for example, and any other artificial partial or complete denture. The term orthodontic procedure refers, inter alia, to any procedure involving the oral cavity and directed to the design, manufacture or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances.

In embodiments, intraoral scanning may be performed on a patient's oral cavity during a visitation of dental office 108. The intraoral scanning may be performed, for example, as part of a semi-annual or annual dental health checkup. The intraoral scanning may also be performed before, during and/or after one or more dental treatments, such as orthodontic treatment and/or prosthodontic treatment. The intraoral scanning may be a full or partial scan of the upper and/or lower dental arches and may be performed in order to gather information for performing dental diagnostics, to generate a treatment plan, to determine progress of a treatment plan, and/or for other purposes. The dental information (intraoral scan data 135A-N) generated from the intraoral scanning may include 3D scan data, 2D color images, NIR, and/or infrared images, and/or ultraviolet images, of all or a portion of the upper jaw and/or lower jaw. The intraoral scan data 135A-N may further include one or more intraoral scans showing a relationship of the upper dental arch to the lower dental arch. These intraoral scans may be usable to determine a patient bite and/or to determine occlusal contact information for the patient. The patient bite may include determined relationships between teeth in the upper dental arch and teeth in the lower dental arch.

For many prosthodontic procedures (e.g., to create a crown, bridge, veneer, etc.), an existing tooth of a patient is ground down to a stump. The ground tooth is referred to herein as a preparation tooth, or simply a preparation. The preparation tooth has a margin line (also referred to as a finish line), which is a border between a natural (unground) portion of the preparation tooth and the prepared (ground) portion of the preparation tooth. The preparation tooth is typically created so that a crown or other prosthesis can be mounted or seated on the preparation tooth. In many instances, the margin line of the preparation tooth is sub-gingival (below the gum line).

Intraoral scanners may work by moving the scanner 150 inside a patient's mouth to capture all viewpoints of one or more tooth. During scanning, the scanner 150 is calculating distances to solid surfaces in some embodiments. These distances may be recorded as images called ‘height maps’ or as point clouds in some embodiments. Each scan (e.g., optionally height map or point cloud) is overlapped algorithmically, or ‘stitched’, with the previous set of scans to generate a growing 3D surface. As such, each scan is associated with a rotation in space, or a projection, to how it fits into the 3D surface.

During intraoral scanning, intraoral scan application 115 may register and stitch together two or more intraoral scans generated thus far from the intraoral scan session to generate a growing 3D surface. In one embodiment, performing registration includes capturing 3D data of various points of a surface in multiple scans, and registering the scans by computing transformations between the scans. One or more 3D surfaces may be generated based on the registered and stitched together intraoral scans during the intraoral scanning. The one or more 3D surfaces may be output to a display so that a doctor or technician can view their scan progress thus far. As each new intraoral scan is captured and registered to previous intraoral scans and/or a 3D surface, the one or more 3D surfaces may be updated, and the updated 3D surface(s) may be output to the display. A view of the 3D surface(s) may be periodically or continuously updated according to one or more viewing modes of the intraoral scan application. In one viewing mode, the 3D surface may be continuously updated such that an orientation of the 3D surface that is displayed aligns with a field of view of the intraoral scanner (e.g., so that a portion of the 3D surface that is based on a most recently generated intraoral scan is approximately centered on the display or on a window of the display) and a user sees what the intraoral scanner sees. In one viewing mode, a position and orientation of the 3D surface is static, and an image of the intraoral scanner is optionally shown to move relative to the stationary 3D surface.

Intraoral scan application 115 may generate one or more 3D surfaces from intraoral scans and may display the 3D surfaces to a user (e.g., a doctor) via a graphical user interface (GUI) during intraoral scanning. In embodiments, separate 3D surfaces are generated for the upper jaw and the lower jaw. This process may be performed in real time or near-real time to provide an updated view of the captured 3D surfaces during the intraoral scanning process. As scans are received, these scans may be registered and stitched to a 3D surface. Quality scores may be determined for various regions of the 3D surface based on one or more criteria. The quality scores may be continuously or periodically updated as information is added from further intraoral scans. As the quality scores gradually change, a visualization of the regions may change in accordance with the changes in the quality scores, enabling a user to have real time or near real time feedback on surface quality during scanning.

When a scan session or a portion of a scan session associated with a particular scanning role (e.g., upper jaw role, lower jaw role, bite role, etc.) is complete (e.g., all scans for an dental site or dental site have been captured), intraoral scan application 115 may generate a virtual 3D model of one or more scanned dental sites (e.g., of an upper jaw and a lower jaw). The final 3D model may be a set of 3D points and their connections with each other (e.g., a mesh). To generate the virtual 3D model, intraoral scan application 115 may register and stitch together the intraoral scans generated from the intraoral scan session that are associated with a particular scanning role. The registration performed at this stage may be more accurate than the registration performed during the capturing of the intraoral scans and may take more time to complete than the registration performed during the capturing of the intraoral scans. In one embodiment, performing scan registration includes capturing 3D data of various points of a surface in multiple scans, and registering the scans by computing transformations between the scans. The 3D data may be projected into a 3D space of a 3D model to form a portion of the 3D model. The intraoral scans may be integrated into a common reference frame by applying appropriate transformations to points of each registered scan and projecting each scan into the 3D space.

In one embodiment, registration is performed for adjacent or overlapping intraoral scans (e.g., each successive frame of an intraoral video). Registration algorithms are carried out to register two adjacent or overlapping intraoral scans and/or to register an intraoral scan with a 3D model, which essentially involves determination of the transformations which align one scan with the other scan and/or with the 3D model. Registration may involve identifying multiple points in each scan (e.g., point clouds) of a scan pair (or of a scan and the 3D model), surface fitting to the points, and using local searches around points to match points of the two scans (or of the scan and the 3D model). For example, intraoral scan application 115 may match points of one scan with the closest points interpolated on the surface of another scan, and iteratively minimize the distance between matched points. Other registration techniques may also be used.

Intraoral scan application 115 may repeat registration for all intraoral scans of a sequence of intraoral scans to obtain transformations for each intraoral scan, to register each intraoral scan with previous intraoral scan(s) and/or with a common reference frame (e.g., with the 3D model). Intraoral scan application 115 may integrate intraoral scans into a single virtual 3D model by applying the appropriate determined transformations to each of the intraoral scans. Each transformation may include rotations about one to three axes and translations within one to three planes.

Intraoral scan application 115 may generate one or more 3D models from intraoral scans and may display the 3D models to a user (e.g., a doctor) via a graphical user interface (GUI). The 3D models can then be checked visually by the doctor. The doctor can virtually manipulate the 3D models via the user interface with respect to up to six degrees of freedom (e.g., translated and/or rotated with respect to one or more of three mutually orthogonal axes) using suitable user controls (hardware and/or virtual) to enable viewing of the 3D model from any desired direction.

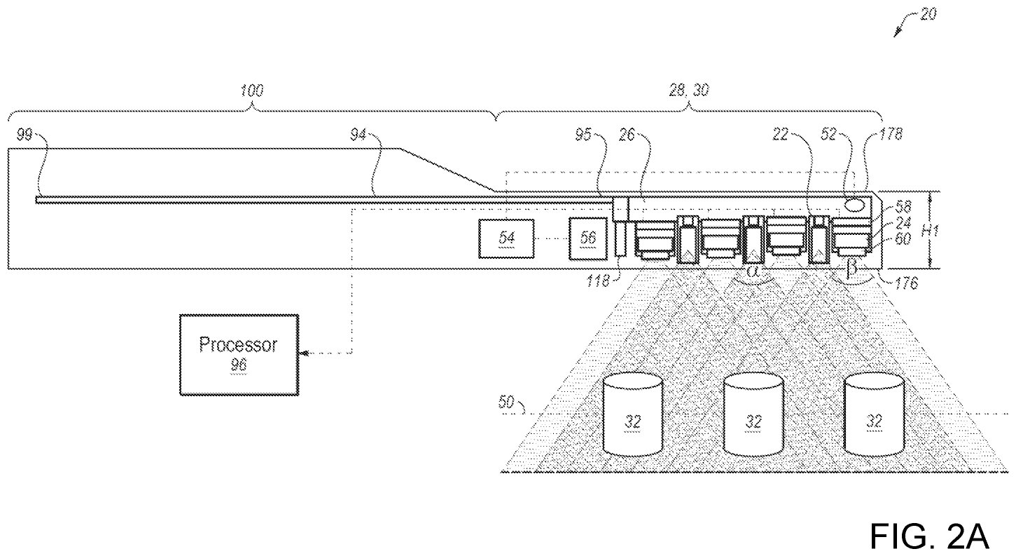

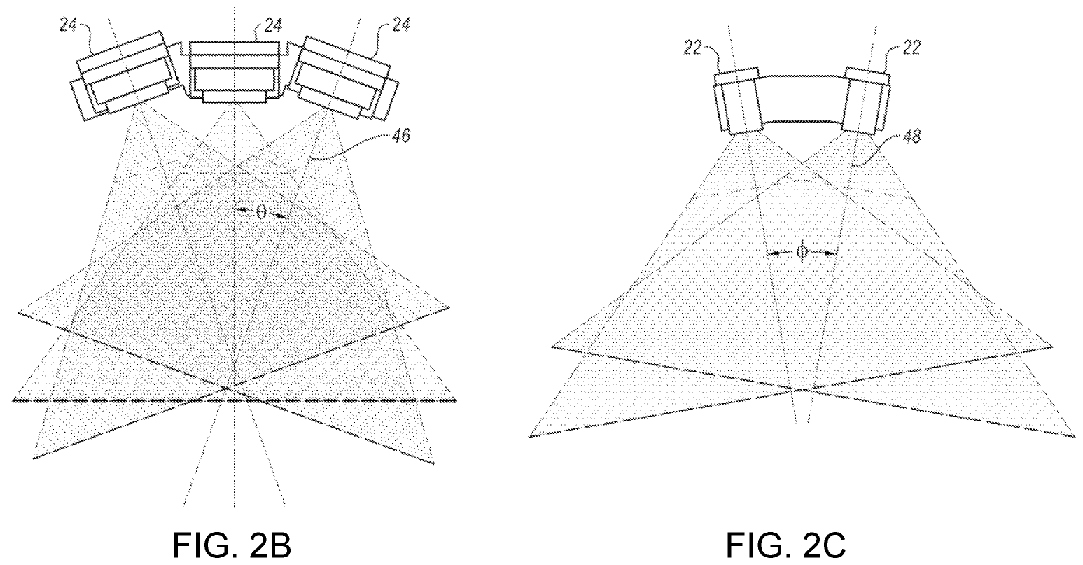

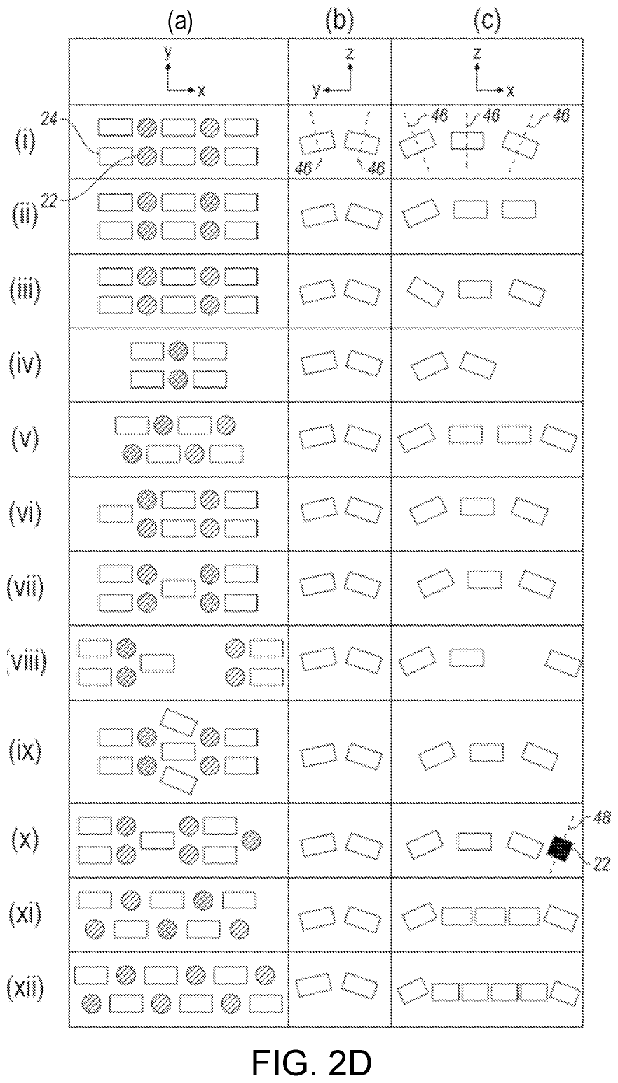

Reference is now made to FIG. 2A, which is a schematic illustration of an intraoral scanner 20 comprising an elongate handheld wand, in accordance with some applications of the present disclosure. The intraoral scanner 20 may correspond to intraoral scanner 150 of FIG. 1 in some embodiments. Intraoral scanner 20 includes a plurality of structured light projectors 22 and a plurality of cameras 24 that are coupled to a rigid structure 26 disposed within a probe 28 at a distal end 30 of the intraoral scanner 20. In some applications, during an intraoral scanning procedure, probe 28 is inserted into the oral cavity of a subject or patient.

For some applications, structured light projectors 22 are positioned within probe 28 such that each structured light projector 22 faces an object 32 outside of intraoral scanner 20 that is placed in its field of illumination, as opposed to positioning the structured light projectors in a proximal end of the handheld wand and illuminating the object by reflection of light off a mirror and subsequently onto the object. Alternatively, the structured light projectors may be disposed at a proximal end of the handheld wand or elsewhere within the wand, and one or more light projectors may face a mirror that redirects structured light from the one or more light projectors onto a surface of an oral cavity. Similarly, for some applications, cameras 24 are positioned within probe 28 such that each camera 24 faces an object 32 outside of intraoral scanner 20 that is placed in its field of view, as opposed to positioning the cameras in a proximal end of the intraoral scanner and viewing the object by reflection of light off a mirror and into the camera. This positioning of the projectors and the cameras within probe 28 enables the scanner to have an overall large field of view while maintaining a low-profile probe. Alternatively, the cameras may be disposed in a proximal end of the handheld wand. Alternatively, one or more cameras may be positioned within the proximal end of the wand and/or elsewhere in the wand, and may face a mirror rather than directly face a surface to be imaged.

In some applications, cameras 24 each have a large field of view ß (beta) of at least 45 degrees, e.g., at least 70 degrees, e.g., at least 80 degrees, e.g., 85 degrees. In some applications, the field of view may be less than 120 degrees, e.g., less than 100 degrees, e.g., less than 90 degrees. In one embodiment, a field of view ß (beta) for each camera is between 80 and 90 degrees, which may be particularly useful because it provided a good balance among pixel size, field of view and camera overlap, optical quality, and cost. Cameras 24 may include an image sensor 58 and objective optics 60 including one or more lenses. To enable close focus imaging, cameras 24 may focus at an object focal plane 50 that is located between 1 mm and 30 mm, e.g., between 4 mm and 24 mm, e.g., between 5 mm and 11 mm, e.g., 9 mm-10 mm, from the lens that is farthest from the sensor. In some applications, cameras 24 may capture images at a frame rate of at least 30 frames per second, e.g., at a frame of at least 75 frames per second, e.g., at least 100 frames per second. In some applications, the frame rate may be less than 200 frames per second.

A large field of view achieved by combining the respective fields of view of all the cameras may improve accuracy due to reduced amount of image stitching errors, especially in edentulous regions, where the gum surface is smooth and there may be fewer clear high resolution 3D features. Having a larger field of view enables large smooth features, such as the overall curve of the tooth, to appear in each image frame, which improves the accuracy of stitching respective surfaces obtained from multiple such image frames.

Similarly, structured light projectors 22 may each have a large field of illumination a (alpha) of at least 45 degrees, e.g., at least 70 degrees. In some applications, field of illumination a (alpha) may be less than 120 degrees, e.g., than 100 degrees.

For some applications, in order to improve image capture, each camera 24 has a plurality of discrete preset focus positions, in each focus position the camera focusing at a respective object focal plane 50. Each of cameras 24 may include an autofocus actuator that selects a focus position from the discrete preset focus positions in order to improve a given image capture. Additionally or alternatively, each camera 24 includes an optical aperture phase mask that extends a depth of focus of the camera, such that images formed by each camera are maintained focused over all object distances located between 1 mm and 30 mm, e.g., between 4 mm and 24 mm, e.g., between 5 mm and 11 mm, e.g., 9 mm-10 mm, from the lens that is farthest from the sensor.

In some applications, structured light projectors 22 and cameras 24 are coupled to rigid structure 26 in a closely packed and/or alternating fashion, such that (a) a substantial part of each camera's field of view overlaps the field of view of neighboring cameras, and (b) a substantial part of each camera's field of view overlaps the field of illumination of neighboring projectors. Optionally, at least 20%, e.g., at least 50%, e.g., at least 75% of the projected pattern of light are in the field of view of at least one of the cameras at an object focal plane 50 that is located at least 4 mm from the lens that is farthest from the sensor. Due to different possible configurations of the projectors and cameras, some of the projected pattern may never be seen in the field of view of any of the cameras, and some of the projected pattern may be blocked from view by object 32 as the scanner is moved around during a scan. In embodiments, intraoral scanner 20 includes laser safety circuitry that ensures that lasers (e.g., blue lasers) of the intraoral scanner 20 will pose no threat to human health. Such laser safety circuitry may include, for example, circuitry that monitors power levels (e.g., by monitoring current or voltage) passing through particular lasers that meets safety restriction levels.

Rigid structure 26 may be a non-flexible structure to which structured light projectors 22 and cameras 24 are coupled so as to provide structural stability to the optics within probe 28. Coupling all the projectors and all the cameras to a common rigid structure helps maintain geometric integrity of the optics of each structured light projector 22 and each camera 24 under varying ambient conditions, e.g., under mechanical stress as may be induced by the subject's mouth. Additionally, rigid structure 26 helps maintain stable structural integrity and positioning of structured light projectors 22 and cameras 24 with respect to each other.

Reference is now made to FIGS. 2B-2C, which include schematic illustrations of a positioning configuration for cameras 24 and structured light projectors 22 respectively, in accordance with some applications of the present disclosure. For some applications, in order to improve the overall field of view and field of illumination of the intraoral scanner 20, cameras 24 and structured light projectors 22 are positioned such that they do not all face the same direction. For some applications, such as is shown in FIG. 2B, a plurality of cameras 24 are coupled to rigid structure 26 such that an angle θ (theta) between two respective optical axes 46 of at least two cameras 24 is 90 degrees or less, e.g., 35 degrees or less. Similarly, for some applications, such as is shown in FIG. 2C, a plurality of structured light projectors 22 are coupled to rigid structure 26 such that an angle q (phi) between two respective optical axes 48 of at least two structured light projectors 22 is 90 degrees or less, e.g., 35 degrees or less.

Reference is now made to FIG. 2D, which is a chart depicting a plurality of different configurations for the position of structured light projectors 22 and cameras 24 in probe 28, in accordance with some applications of the present disclosure. Structured light projectors 22 are represented in FIG. 2D by circles and cameras 24 are represented in FIG. 2D by rectangles. It is noted that rectangles are used to represent the cameras, since typically, each image sensor 58 and the field of view ß (beta) of each camera 24 have aspect ratios of 1:2. Column (a) of FIG. 2D shows a bird's eye view of the various configurations of structured light projectors 22 and cameras 24. The x-axis as labeled in the first row of column (a) corresponds to a central longitudinal axis of probe 28. Column (b) shows a side view of cameras 24 from the various configurations as viewed from a line of sight that is coaxial with the central longitudinal axis of probe 28 and substantially parallel to a viewing axis of the intraoral scanner. Similar to as shown in FIG. 2B, column (b) of FIG. 2D shows cameras 24 positioned so as to have optical axes 46 at an angle of 90 degrees or less, e.g., 35 degrees or less, with respect to each other. Column (c) shows a side view of cameras 24 of the various configurations as viewed from a line of sight that is perpendicular to the central longitudinal axis of probe 28.

Typically, the distal-most (toward the positive x-direction in FIG. 2D) and proximal-most (toward the negative x-direction in FIG. 2D) cameras 24 are positioned such that their optical axes 46 are slightly turned inwards, e.g., at an angle of 90 degrees or less, e.g., 35 degrees or less, with respect to the next closest camera 24. The camera(s) 24 that are more centrally positioned, i.e., not the distal-most camera 24 nor proximal-most camera 24, are positioned so as to face directly out of the probe, their optical axes 46 being substantially perpendicular to the central longitudinal axis of probe 28. It is noted that in row (xi), a projector 22 is positioned in the distal-most position of probe 28, and as such the optical axis 48 of that projector 22 points inwards, allowing a larger number of spots projected from that particular projector 22 to be seen by more cameras 24.

In embodiments, the number of structured light projectors 22 in probe 28 may range from two, e.g., as shown in row (iv) of FIG. 2D, to six, e.g., as shown in row (xii). Typically, the number of cameras 24 in probe 28 may range from four, e.g., as shown in rows (iv) and (v), to seven, e.g., as shown in row (ix). It is noted that the various configurations shown in FIG. 2D are by way of example and not limitation, and that the scope of the present disclosure includes additional configurations not shown. For example, the scope of the present disclosure includes fewer or more than five projectors 22 positioned in probe 28 and fewer or more than seven cameras positioned in probe 28.

In an example application, an apparatus for intraoral scanning (e.g., an intraoral scanner 150) includes an elongate handheld wand comprising a probe at a distal end of the elongate handheld wand, at least two light projectors disposed within the probe, and at least four cameras disposed within the probe. Each light projector may include at least one light source configured to generate light when activated, and a pattern generating optical element that is configured to generate a pattern of light when the light is transmitted through the pattern generating optical element. Each of the at least four cameras may include a camera sensor (also referred to as an image sensor) and one or more lenses, wherein each of the at least four cameras is configured to capture a plurality of images that depict at least a portion of the projected pattern of light on an intraoral surface. A majority of the at least two light projectors and the at least four cameras may be arranged in at least two rows that are each approximately parallel to a longitudinal axis of the probe, the at least two rows comprising at least a first row and a second row.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row may be positioned such that optical axes of the cameras in the first row are at an angle of 90 degrees or less with respect to optical axes of the cameras in the second row from a line of sight that is coaxial with the longitudinal axis of the probe. A remainder of the at least four cameras other than the distal-most camera and the proximal-most camera have optical axes that are substantially parallel to the longitudinal axis of the probe. Each of the at least two rows may include an alternating sequence of light projectors and cameras.

In a further application, the at least four cameras comprise at least five cameras, the at least two light projectors comprise at least five light projectors, a proximal-most component in the first row is a light projector, and a proximal-most component in the second row is a camera.

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row may be positioned such that the optical axes of the cameras in the first row are at an angle of 35 degrees or less with respect to the optical axes of the cameras in the second row from the line of sight that is coaxial with the longitudinal axis of the probe.

In a further application, the at least four cameras may have a combined field of view of 25-45 mm along the longitudinal axis and a field of view of 20-40 mm along a z-axis corresponding to distance from the probe.

Returning to FIG. 2A, for some applications, there is at least one uniform light projector 118 (which may be an unstructured light projector that projects light across a range of wavelengths) coupled to rigid structure 26. Uniform light projector 118 may transmit white light onto object 32 being scanned. At least one camera, e.g., one of cameras 24, captures two-dimensional color images of object 32 using illumination from uniform light projector 118.

Processor 96 may run a surface reconstruction algorithm that may use detected patterns (e.g., dot patterns) projected onto object 32 to generate a 3D surface of the object 32. In some embodiments, the processor 96 may combine at least one 3D scan captured using illumination from structured light projectors 22 with a plurality of intraoral 2D images captured using illumination from uniform light projector 118 in order to generate a digital three-dimensional image of the intraoral three-dimensional surface. Using a combination of structured light and uniform illumination enhances the overall capture of the intraoral scanner and may help reduce the number of options that processor 96 needs to consider when running a correspondence algorithm used to detect depth values for object 32. In one embodiment, the intraoral scanner and correspondence algorithm described in U.S. application Ser. No. 16/446,181, filed Jun. 19, 2019, is used. U.S. application Ser. No. 16/446,181, filed Jun. 19, 2019, is incorporated by reference herein in its entirety. In embodiments, processor 96 may be a processor of computing device 105 of FIG. 1. Alternatively, processor 96 may be a processor integrated into the intraoral scanner 20.

For some applications, all data points taken at a specific time are used as a rigid point cloud, and multiple such point clouds are captured at a frame rate of over 10 captures per second. The plurality of point clouds may then be stitched together using a registration algorithm, e.g., iterative closest point (ICP), to create a dense point cloud. A surface reconstruction algorithm may then be used to generate a representation of the surface of object 32.

For some applications, at least one temperature sensor 52 is coupled to rigid structure 26 and measures a temperature of rigid structure 26. Temperature control circuitry 54 disposed within intraoral scanner 20 (a) receives data from temperature sensor 52 indicative of the temperature of rigid structure 26 and (b) activates a temperature control unit 56 in response to the received data. Temperature control unit 56, e.g., a PID controller, keeps probe 28 at a desired temperature (e.g., between 35 and 43 degrees Celsius, between 37 and 41 degrees Celsius, etc.). Keeping probe 28 above 35 degrees Celsius, e.g., above 37 degrees Celsius, reduces fogging of the glass surface of intraoral scanner 20, through which structured light projectors 22 project and cameras 24 view, as probe 28 enters the intraoral cavity, which is typically around or above 37 degrees Celsius. Keeping probe 28 below 43 degrees, e.g., below 41 degrees Celsius, prevents discomfort or pain.

In some embodiments, heat may be drawn out of the probe 28 via a heat conducting element 94, e.g., a heat pipe, that is disposed within intraoral scanner 20, such that a distal end 95 of heat conducting element 94 is in contact with rigid structure 26 and a proximal end 99 is in contact with a proximal end 100 of intraoral scanner 20. Heat is thereby transferred from rigid structure 26 to proximal end 100 of intraoral scanner 20. Alternatively, or additionally, a fan disposed in a handle region 174 of intraoral scanner 20 may be used to draw heat out of probe 28.

FIGS. 2A-2D illustrate one type of intraoral scanner that can be used for embodiments of the present disclosure. However, it should be understood that embodiments are not limited to the illustrated type of intraoral scanner. In one embodiment, intraoral scanner 150 corresponds to the intraoral scanner described in U.S. application Ser. No. 16/910,042, filed Jun. 23, 2020, and entitled “Intraoral 3D Scanner Employing Multiple Miniature Cameras and Multiple Miniature Pattern Projectors,” which is incorporated by reference herein. In one embodiment, intraoral scanner 150 corresponds to the intraoral scanner described in U.S. application Ser. No. 16/446,181, filed Jun. 19, 2019, and entitled “Intraoral 3D Scanner Employing Multiple Miniature Cameras and Multiple Miniature Pattern Projectors,” which is incorporated by reference herein.

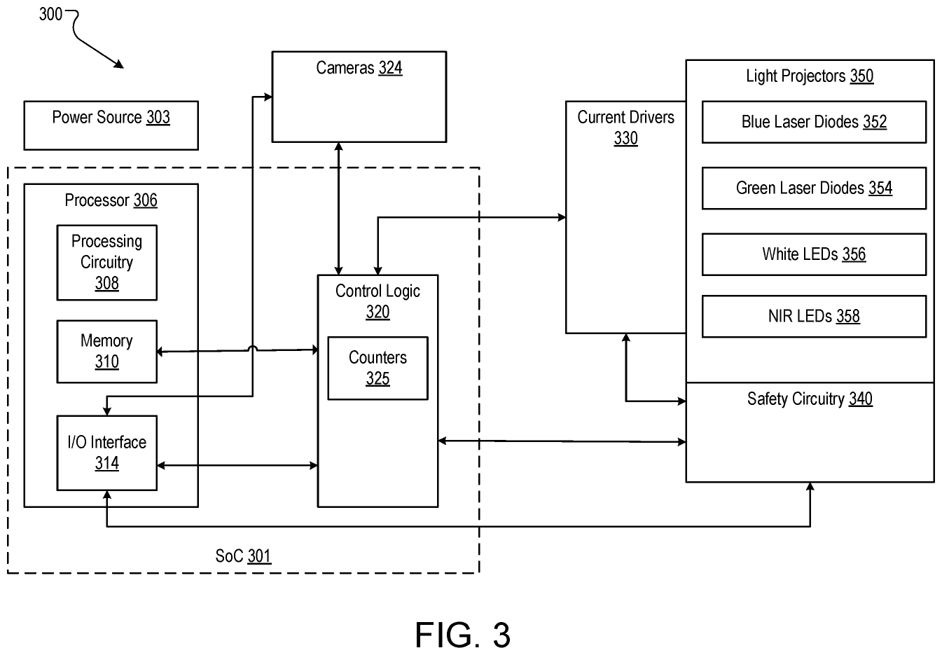

FIG. 3 is a schematic block diagram of an intraoral scanner 300 in accordance with some applications of the present disclosure. In at least some embodiments, the intraoral scanner 300 includes a power source 303, and a system on a chip (SoC) 301 including a processor 306 and control logic 320. The intraoral scanner 300 may further include cameras 324, current drivers 330, safety circuitry 340, and light projectors 350, all of which will be discussed in detail. As discussed previously, in various embodiments, the light projectors 350 include blue laser diodes 352, green laser diodes 354, white LEDs 358, and near-infrared LEDs 358, or some combination of these different light projectors (e.g., light sources). In embodiments, the processor 306 includes processing circuitry 308, memory 310, and an input/output (I/O) interface 314. The I/O interface 314, for example, may enable interchange of data and signals with at least the control logic 320, the cameras, 324, and the safety circuitry 340.

In at least some embodiments, the intraoral scanner 300 is a system or device consistent with the intraoral scanner 20 illustrated and discussed with reference to FIGS. 2A-2D. For example, the cameras 324 may be the cameras 24, the light projectors 350 may be the light projectors 22, and the processor 306 may be the processor 96. In some embodiments, the processor 306 is a central processing unit (CPU), a microprocessor, or other processing core configured to execute instructions to perform various operations, e.g., where the instructions can be embodied in software and/or firmware. In some embodiments, the control logic 320 is an FPGA, an ASIC, or other programmed hardware or programmed processor. In at least some embodiments, the processor 306 and the control logic 320 are instantiated on the same printed circuit board (PCB), e.g., on the SoC 301 for better performance. In embodiments, the processor 306 is configured to execute instructions to program the control logic 320 to perform real-time control of the current drivers 330 (e.g., via enable switches), of the light projectors 350 (e.g., via load switches), and of the cameras 324. In embodiments, the structure that holds and connects the light projectors 350 and the cameras 324 include that are connected to a data input port of the SoC 301, e.g., that is coupled to the I/O interface 314.

In various embodiments, the processor 306 programs the control logic 320 with various sequences of activation for activating the light projectors 350 in a manner that is synched with sequences of activation for activating certain cameras 324. For example, the cameras 324 can record images at tens to hundreds of frames per second while, during those frames, light pulses are issued from certain ones of the light projectors 350 synchronized to the camera frame timing. In embodiments, at certain frames, white LED light is used, at others NIR LED light is used, and at others blue laser diode is used, followed by green laser diode, or other combination of sequences.

In at least some embodiments, the processor 306 also programs the control logic 320 with pulse length values that will govern monitoring for safe pulse length durations of the different light projectors 350. For example, the light pulses from blue laser diodes 352 may be limited to two milliseconds (2 ms) while light pulses from green laser diodes 354 may be limited to 6 ms, just for purposes of explanation, as different time pulse limitations are envisioned. The control logic 320 may include counters 325, e.g., a counter for each output to a light projector 350 that tracks a particular amount of time, e.g., 2 ms for a blue laser diode or 6 ms for a green laser diode. In embodiments, in response to a counter 325 satisfying a threshold amount of time of that counter, e.g., meeting or exceeding a pulse length value for a particular light projector type, the control logic 320 sends a message to the processor 306 such as an alert signal (LSR_INT #), and then shuts itself down. The processor 306 can receive the alert signal and set the intraoral scanner 300 into a fatal error state, e.g., by storing or writing a fatal error flag to a reserved location in memory (or other memory) that has to be cleared before scanning operation is resumed.

The fatal error state may thus cause the intraoral scanner 300 to be disabled from scanning until cleared by a technician. For example, in embodiments, whenever a scanning application is started, the fatal error flag ensures that no scan can start and that the intraoral scanner 300 cannot be used for scanning. A service engineer can access the system, look at the error and decide whether the intraoral scanner 300 should be sent to be fixed or the fatal error flag can be reset by clearing the flag.

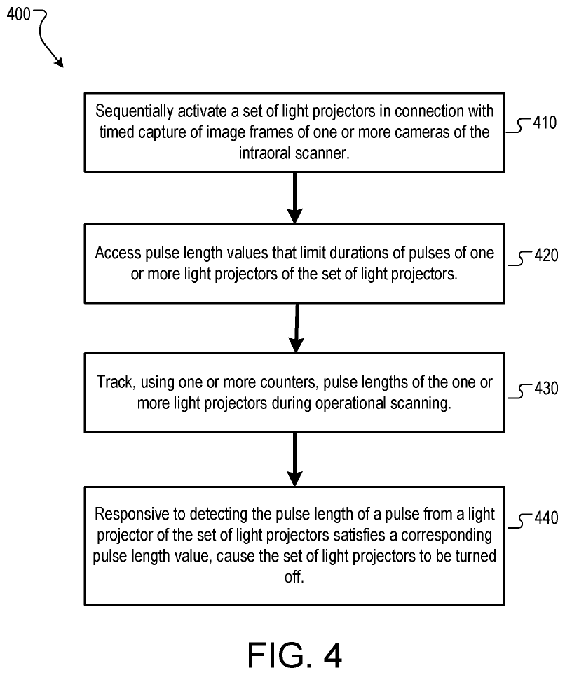

FIG. 4 is a flow chart for a method 400 of monitoring and ensuring safe operations of a plurality of light projectors, in accordance with embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device, to include firmware), or a combination thereof. In some embodiments, the method 400 is performed by the control logic 320 or by a combination of the control logic 320 and the processor 306 of FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic sequentially activates a set of light projectors in connection with timed capture of image frames of one or more cameras of the intraoral scanner 300. Activation of light projectors will be discussed in more detail hereinafter.

At operation 420, the processing logic accesses pulse length values that limit durations of pulses of one or more light projectors of the set of light projectors. For example, the pulse length values may be hard-wired within or stored accessible by the control logic.

At operation 430, the processing logic tracks, using one or more of the counters 325, pulse lengths of the one or more light projectors during operational scanning.

At operation 440, responsive to determining that the pulse length of a pulse from a light projector of the set of light projectors satisfies a corresponding pulse length value, the processing logic causes the set of light projectors to be turned off, e.g., disabled. This action may be immediate to ensure any dangerous condition of a light projector (such as of a blue laser diode) is stopped before damaging a patient or operator. In various embodiments, as an extension to operation 440, the processing logic also triggers the processor 306 of the intraoral scanning system to enter a fatal error state that causes the intraoral scanning system to become deactivated.

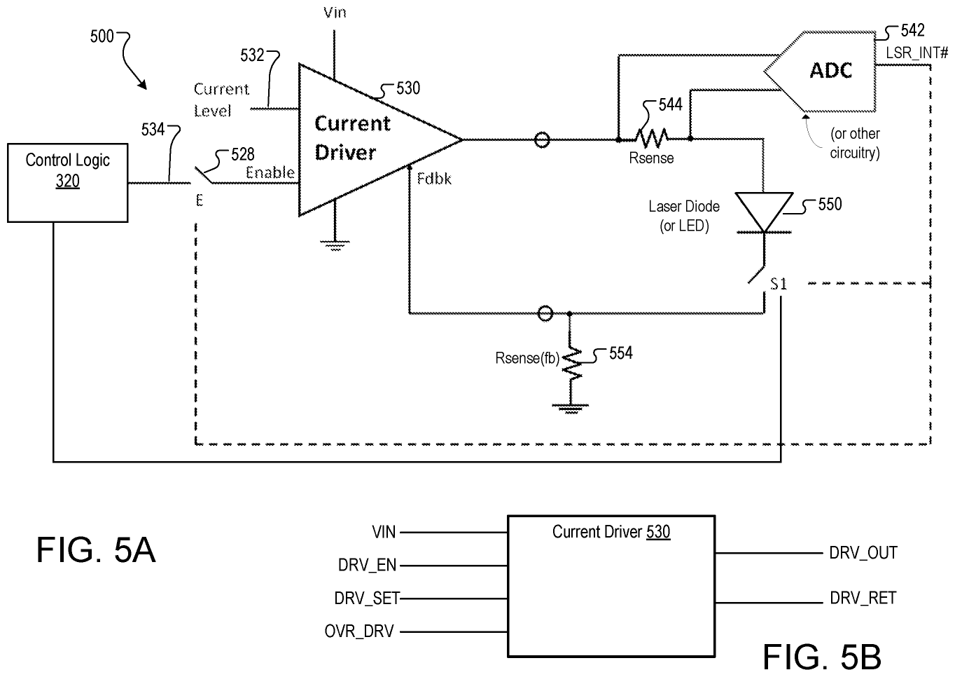

In various embodiments, as discussed in more detail with reference to FIGS. 5A-5B, the method 400 further includes the processing logic setting an overdrive signal routed to one or more drivers that are operatively coupled to the one or more blue laser diodes. In embodiments, the overdrive signal causes the one or more drivers to operate in a high current state.

In various embodiments, as discussed in more detail with reference to FIGS. 5A-5B, the method 400 further includes the processing logic setting a current drive signal to set a current level at which one or more of drivers will drive the one or more blue laser diodes.

In various embodiments, as discussed in more detail with reference to FIGS. 5A-5B, the method 400 further includes programming the control logic with a sequence of activations of the set of lights; and a different pulse length value for each type of light projector of the set of light projectors. For example, the set of light projectors may include blue laser diodes, green laser diodes, white light-emitting diodes (LEDs), and near-infrared LEDs.

FIG. 5A is driver circuit 500 for driving a laser diode and integrated safety circuitry, in accordance with some applications of the present disclosure. Such laser safety circuitry may include, for example, circuitry that monitors power levels (e.g., by monitoring current or voltage) passing through particular lasers that meets safety restriction levels. In some embodiments, the driver circuit 500 includes a current driver 530 that is coupled to an input voltage (from Vin), a current level line 532, and an enable signal line 534. An enable signal may be selectively received from the control logic 320 over the enable signal line 534 responsive to closing an enable switch 528 (e.g., a driver-enable switch). Once enabled, the current driver 530 outputs a current to a light projector 550 (such as a laser diode, for example).

In at least some embodiments, the safety circuitry (e.g., the safety circuitry 340 of FIG. 3) includes a sense resistor 544 (Rsense) coupled to or positioned within an output line of the current driver 530, an ADC 542 coupled to the sense resistor 544, and a load switch (S1). The driver circuit 500 may also include a feedback resistor 554 that feeds back a current to the current driver 530 that flows through a current loop of the driver circuit 500.

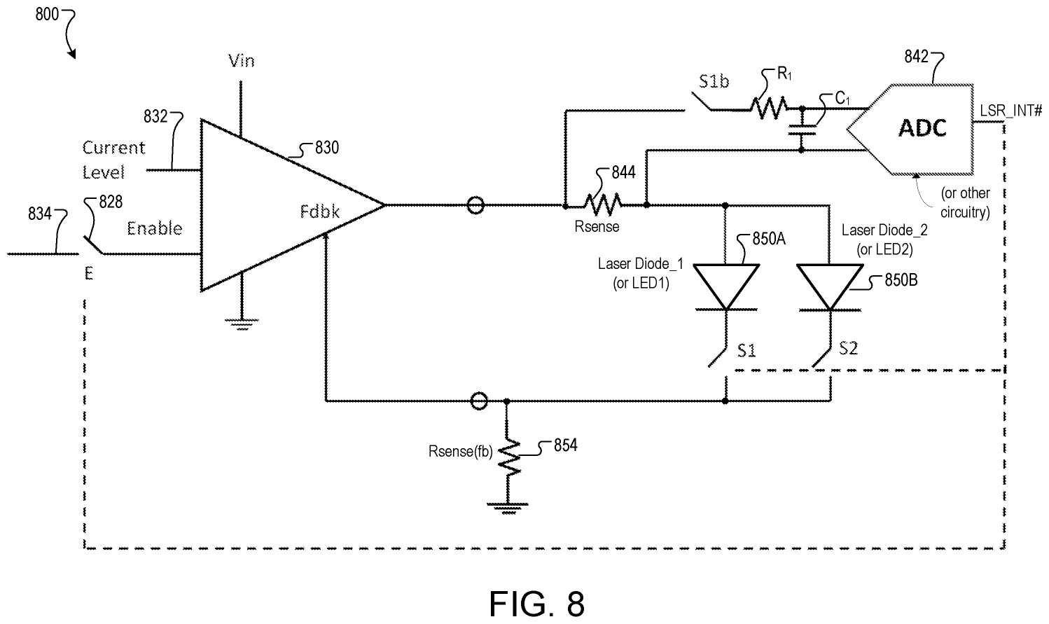

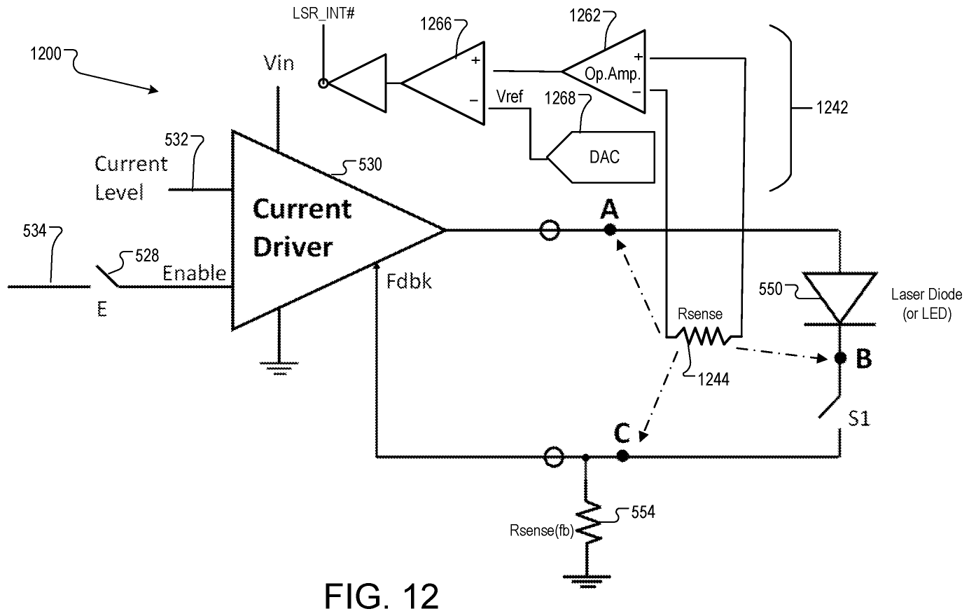

As will be discussed in more detail with reference to FIGS. 8-11, there may be a set of drivers having multiple drivers that drive respective light projectors 350 (FIG. 3) of different types, sometimes multiple light projectors being driven by the same driver. Further, sense resistors of the safety circuitry 340 (FIG. 3) may be located in various different locations of the driver circuits (see FIG. 12). Thus, although aspects of the FIGS. 5A-7B are discussed in additional detail with reference to a single driver and light projector, the principles discussed with reference to FIGS. 5A-7B are applicable to any coupled driver and light projector referenced in FIGS. 8-11. Once current or voltage levels are sensed through the sense resistors, safety circuitry can monitor for exceeding a particular power level associated with safety power restriction levels and trigger alerts when the power restriction levels are exceeded.

FIG. 5B is a schematic diagram of the inputs and outputs of an exemplary current driver 530, such as the current driver 530, useable in the driver circuits referred to herein, in accordance with some applications of the present disclosure. In some embodiments, the current driver 530 includes various inputs and outputs. While not exhaustive, the inputs may include a voltage input (Vin) to provide power to the current driver 530, a drive enable signal (DRV_EN), a drive set signal (DRV_SET), an overdrive signal (OVR_DRV), and the outputs may include a drive out signal (DRV_OUT) and a drive return signal (DRV_RET).

In some embodiments, the drive enable signal is an ON or OFF signal that activates or deactivates the current driver 530, respectively. In embodiments, the drive set signal is an analog voltage (at the current level line 532) that will determine current level that will drive the light projectors 350 such as the light projector 550. In embodiments, the overdrive signal is a low or high signal (e.g., 0 or 1) that causes the current driver 530 to operate at either a lower current range or at a higher current range (not shown), depending on application of the intraoral scanner. In embodiments, and with additional reference to FIG. 5A, the ADC 542 is configured to monitor, through the sense resistor 544, an output current from the current driver 530, compare the output current to a threshold current, and in response to the output current satisfying a threshold current, activate an alert interrupt signal that causes the enable switch to be turned off and optionally also the load switch S1 to be turned off. In embodiments, the processor 306 programs the ADC 542 with the threshold current amount or value for purposes of comparison, within the ADC 542, to the measured current.

In at least some embodiments, for each cycle, per frame of the cameras 324 and before the frame starts, the control logic 320 sets the drive set signal (DRV_SET) at a particular analog voltage level, sets the overdrive signal (OVR_DRV) as high or low, and then causes the proper load switch to close, e.g., in this case the load switch S1, although subsequent figures illustrate more than one light projector 350 being driven by any given current driver. The control logic 320 may then subsequently enable the current driver 530 with the drive enable signal (DRV_EN), causing the current driver 530 to turn on and drive the light projector 550. Upon the sequencing indicating to turn the light projector 550 off, the control logic 320 may deassert (or remove) the drive enable signal (DRV_EN) and cause the load switch S1 to turn off to disconnect the light projector 550 from any current flow, which causes the sequencing to arrive at an end of cycle for that frame. In embodiments, this series of operations is performed when transitioning to a different color LED or laser diode for a new frame, e.g., because the different light projectors 350 have different current levels so the DRV_SET and OVR_DRV may change for each scanner cycle. For example, in embodiments of driving the blue laser diodes 352, the control logic 320 forces the overdrive signal to a low state, limiting current (and thus intensity) of the blue laser diodes 352.

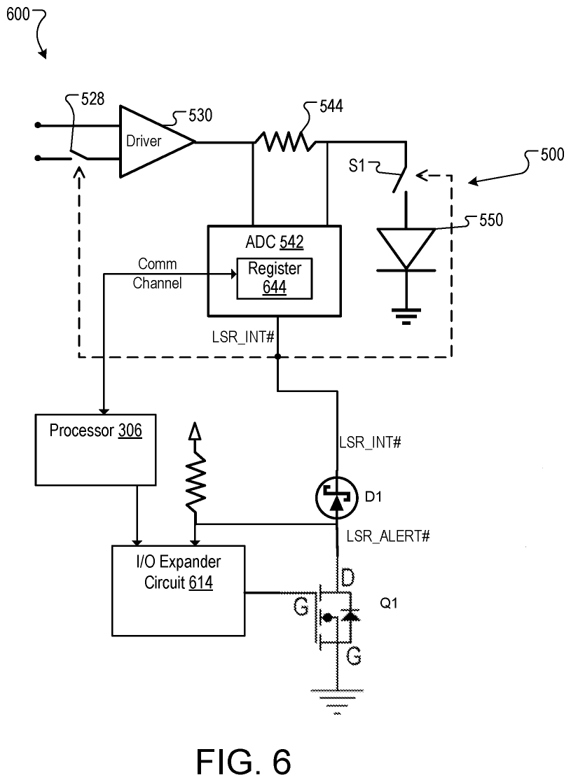

FIG. 6 is a schematic block diagram of an intraoral scanner 600 illustrating how the processor 306 interacts with the driver circuit 500 and an integrated safety circuitry to ensure safe operation of laser diodes, in accordance with some applications of the present disclosure. The safety circuitry, for example, is identified as safety circuitry 340 in FIG. 3. Thus, in embodiments, the intraoral scanner 600 is similar to the intraoral scanner 300 of FIG. 3, but with some clarifications by way of additions. In these embodiments, the ADC 542 includes a register 644, which may be some type of memory register or hardware register in which to store a status signal, to include an alert interrupt signal (LSR_INT #), as will be explained in detail. The intraoral scanner 600 may further include an I/O expander circuit 614 coupled between the processor 306 and the ADC 542 of the safety circuitry. In embodiments, the I/O expander 614 is included either within the I/O interface 314 or within the safety circuitry 340 that is directly coupled to the safety circuitry 340, for example.

As previously mentioned, in some embodiments, the ADC 542 detects overcurrent, e.g., that the current sensed in the output of the current driver 530 satisfies (or meets or exceeds) a threshold current that causes the power through a particular laser or laser diode to exceed safety power restriction levels. If these power restriction levels were exceeded, for example, the particular laser or laser diode could damage the eyes of a patient being scanned by the intraoral scanner. In some embodiments, the threshold current is stored within the control logic 320 or in the register 644 (or other memory) of the ADC 542. In response to detecting such overcurrent, the ADC 542 may set an alert interrupt signal (LSR_INT # that creates the LSR_ALERT #signal) as an alarm, which is also connected as a digital input to the processor 306. The alert interrupt signal may also be stored as an alert flag in the register 644. This alert interrupt signal (LSR_ALARM #) may be a digital signal to disconnect or turn off the enable switches (in this embodiment the enable switch 528) and turn off the load switches (in this embodiment, the load switch S1) from the current drivers (in this embodiment, the current driver 530). This operation of the safety circuitry may be viewed as a hardware safety protection feature, for example.

In various embodiments, the ADC 542 communicates the alert interrupt signal to the processor 306, e.g., via the control logic 320 or directly to the processor 306 via the I/O interface 314 (FIG. 1), for example. In response to detecting the alert interrupt signal, in at least some embodiments, the processor 306 determines (or confirms) the ADC 542 has activated the interrupt alert signal by reading the alert flag from the register 644 and entering a fatal error state that inactivates the intraoral scanner 300 or 600.

In some embodiments of the intraoral scanner 300 or 600, when the processor 306 reads the alert flag out of the register 644, the ADC 542 automatically clears the alert flag in the register 644. This can result in the intraoral scanner 300 or 600 beginning to function normally again, e.g., the control logic 320 variably turning on the enable switches and the load switches of the safety circuitry 340. This result may be unwanted due to the risks with continued operation having been detected with the overcurrent situation through one or more of the light projectors 350, particularly any blue laser diodes 352 that carry the highest risk to the human eye.

Accordingly, in some embodiments, to avoid the ADC 542 clearing of its alert flag causing the intraoral scanner to resume normal operation, a field effect transistor (FET) Q1 (or other functionally acceptable transistor) is employed that is controllable by the processor 306 to operate in an open drain mode. For example, the FET includes a gate coupled to the processor 306 via the I/O expander circuit 614. An I/O expander circuit may be understood to provide the ability to implement additional input and outputs on a microprocessor (MPU) or microcontroller (MCO) system, e.g., by employing an efficient data bus interface to reduce to the I/O requirement of the MPU or MCU. In some embodiments, the I/O expander circuit 614 is not used. In embodiments, a diode D1 is coupled between a drain of the FET and: i) the enable switch 528; and ii) the load switch, S1. In some embodiments, diode D1 is a Schottky diode or other functionally equivalent diode.

In at least some embodiments, the processor 306 is configured to, responsive to receiving the alert interrupt signal from the ADC 542, cause the FET Q1 to turn on, forcing the enable switch 528 and the load switch S1 to continue to receive the alert interrupt signal, e.g., a low voltage signal that keeps these enable and load switches turned off. In embodiments, the FET Q1 turning on forces the laser alert signal (LSR_ALERT #) to go low. Thus, even if the ADC 542 stops driving the alert interrupt signal after the reading of the alert flag by the processor 306, the FET Q1 may be controlled to ensure that the enable and load switches are inactive (or disabled). In embodiments, when the processor 306 determines that the alert interrupt signal was activated by the ADC 542, the processor 306 sets the intraoral scanner 300 or 600 to a fatal error state. The laser alert signal may be sent to the control logic 320 and/or to other circuitry of the intraoral scanner 300 or 600, which thus continues to remain deactivated. In some embodiments, the intraoral scanner 300 or 600 may remain deactivated until the processor 306 sets a fatal error flag that does not allow future scans. In some embodiments, a technician clears the fatal error flag, allowing emitting light in future scans.

In various embodiments, since each light projector 350 requires two switches (the enable switch 528 and load switch S1) to be closed in order to activate the light projector 550, it is clear that a single fault of a shorted switch is not harmful since the projector is not activated until the other switch is closed. However, in some embodiments, in order to be a safe system and to prevent double faults case, the intraoral scanner 300 or 600 is designed to detect such a fault.

In embodiments, detection of failure in the enable switch 528 or the S1 switch could be done by a built-in self-test (BIT), may be run periodically since the BIT detects a single fault that does not cause a dangerous state of the intraoral scanner 300 or 600. The danger is only if two faults are both triggered, e.g., both enable and load switches are stuck on “ON.” In various embodiments, the BIT can test the proper function of either test enable switch 528, the load switch S1, or test both switches. In one embodiment, to test the enable switch 528, the control logic 320 causes the enable switch 528 to be turned OFF, causes the load switch S1 to be turned OFF while confirming the input current is low, and causes the load switch S1 to be turned ON while confirming the input current remains low, e.g., close to zero (“0”) milliamperes. By passing this particular BIT, the enable switch 528 is indeed OFF. For completeness, the BIT can also be configured to check whether setting the enable switch 528 to ON causes the current to get to the desired (and high) value.

In one embodiment, to test the load switch S1, the control logic 320 causes the load switch S1 to be turned off, causes the enable switch 528 to be turned off while confirming the output current is low, and causes the enable switch 528 to be turned on while confirming the output current remains low, e.g., close to zero (“0”) milliamperes. By passing this particular BIT, the load switch S1 is indeed OFF. For completeness, the BIT can also be configured to check whether setting the load switch S1 to ON causes the current to get to the desired (and high) value.

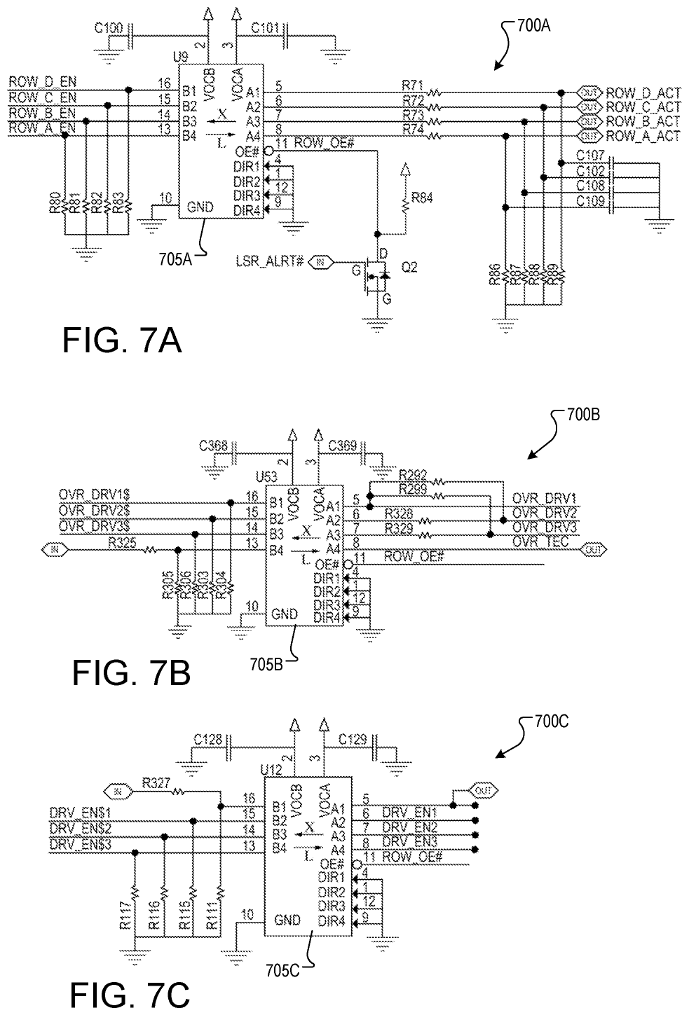

FIG. 7A is an exemplary row enable voltage shift circuit 700A with circuitry that acts on a laser alert signal to disable load switches, in accordance with some applications of the present disclosure. As illustrated in FIG. 7A, in some embodiments, the laser alert signal (LSR_INT #) causes a FET Q2 in the row enable voltage shift circuit 700A to be turned OFF, driving the row enable signal (ROW_OE #) to be high. Driving the row enable signal (ROW_OE #) high disconnects the current driver 530 and disconnects the load switches as well, e.g., via signals ROW_A_ACT (for the blue laser diodes 352), ROW_B_ACT (for the green laser diodes 354), ROW_C_ACT (for the white LEDs 356), and ROW_D_ACT (for the NIR LEDs 358), which are connected to pull up resistors (not shown). In embodiments, these load switch signals are output from a voltage level shifter 705A, e.g., which in one example is a 74AVC4TD245GU manufactured by Nexperia USA Inc. A voltage level shifter generally shifts the voltage level of the control signals to a correct voltage level.

FIG. 7B is an exemplary overdrive voltage shift circuit 700B with circuitry that acts on a laser alert signal to disconnect overdrive signals, in accordance with some applications of the present disclosure. Causing the row enable signal (ROW_EN #), discussed with reference to FIG. 7A, to go high may also disable the overdrive signals to various current drivers, e.g., OVR_DRV1, OVR_DRV2, and OVER_DRV3, which are connected to pull down resistors (not shown). In embodiments, these overdrive signals are output from a voltage level shifter 705B, e.g., which in one example is a 74AVC4TD245GU manufactured by Nexperia USA Inc.

FIG. 7C is an exemplary driver enable voltage shift circuit 700C with circuitry that acts on a laser alert signal to disconnect driver enable signals, in accordance with some applications of the present disclosure. Causing the row enable signal (ROW_EN #), discussed with reference to FIG. 7A, to go high and may also disable the drive enable signals to various current drivers, e.g., DRV_EN1, DRV_EN 2, and DRV_EN 3, which are connected to pull down resistors (not shown). In embodiments, these drive enable signals are output from a voltage level shifter 705C, e.g., which in one example is a 74AVC4TD245GU manufactured by Nexperia USA Inc.

In some embodiments, each of the voltage level shifters 705A, 705B, and 705C illustrated in FIGS. 7A-7C is shifts the voltage level of the control signals, which are generated by the control logic 320 to the switches of the safety circuitry 340, to a correct voltage level for controlling the switches, e.g., turning the switches ON and OFF. In this way, the laser alert signal (LSR_ALERT #) is able to automatically deassert (or disable) these control signals.

FIG. 8 is a schematic diagram of a driver circuit 800, which drives two or more laser diodes using a single driver, with integrated safety circuitry, in accordance with some applications of the present disclosure. In embodiments, and as a variation to the driver circuit 500 (FIG. 5A), the driver circuit 800 includes a current driver 830 that receives an input voltage (from Vin), a current level line 832, and an enable signal line 834. An enable signal may be selectively received from the control logic 320 over the enable signal line 834 responsive to closing an enable switch 828 (e.g., a driver-enable switch). Once enabled, in one embodiment, the current driver 830 outputs a current to one of a first light projector, e.g., a first laser diode 850A, or a second light projector, e.g., a second laser diode 850B. In at least one embodiment, the first laser diode 850A and the second laser diode 850B is each a blue laser diode 352 while, in another embodiments, the first laser diode 850A is a blue laser diode and the second laser diode 850B is a green laser diode 354. Further, each light projector discussed herein may be understood to include one or more light projectors connected in series and therefore that act together, being driven by a common current from a current driver.

In at least some embodiments, the safety circuitry (e.g., the safety circuitry 340 of FIG. 3) includes a sense resistor 844 (Rsense) coupled or positioned within an output line of the current driver 830, an ADC 842 coupled to the sense resistor 844, and a first load switch S1 coupled to the first laser diode 850A, and a second load switch S2 coupled to the second laser diode 850B. The driver circuit 800 may also include a feedback resistor 854 that feeds back a current to the current driver 830 that flows through a current loop of the driver circuit 800. In embodiments, the ADC 842 is configured to monitor, through the sense resistor 844, an output current from the current driver 530, compare the output current to a threshold current, and in response to the output current satisfying a threshold current, activate an alert interrupt signal that causes the enable switch to be turned off and optionally also the load switch S1 and/or S2 to be turned off. In embodiments, the processor 306 programs the ADC 842 with the threshold current amount or value for purposes of comparison, within the ADC 842, to the measured current.

In some embodiments, the safety circuitry of the driver circuit 800 further includes a resistor R₁ coupled inline to an upper lead line that is coupled to the ADC 842, a capacitor C₁ coupled across the lead lines from the ADC 842, and an ADC switch S1b coupled inline on the upper lead line between the ADC 842 and the sense resistor 844. The ADC switch S1b may select the source of the measurement taken by the safety circuitry, including the ADC 842, coupled to the sense resistor 844. The resistor R₁ and the capacitor C₁ may be employed to read an estimate of the current through either of the first laser diode 850A or the second laser diode 850B, depending on which is switched on via first load switch S1 or the second load switch S2. In some embodiments, S1b is synchronized to S1, and so the ADC 842 can measure the current of the first laser diode 850A. The current read out of the sense resistor 844, for example, may be synchronized with a current pulse through the first or second laser diode 850A or 850B. In the alternative, the current pulses are integrated by the capacitor C₁ that has a small time constant for charging and a long time constant for discharging, keeping the indication of each current pulse for a longer time.

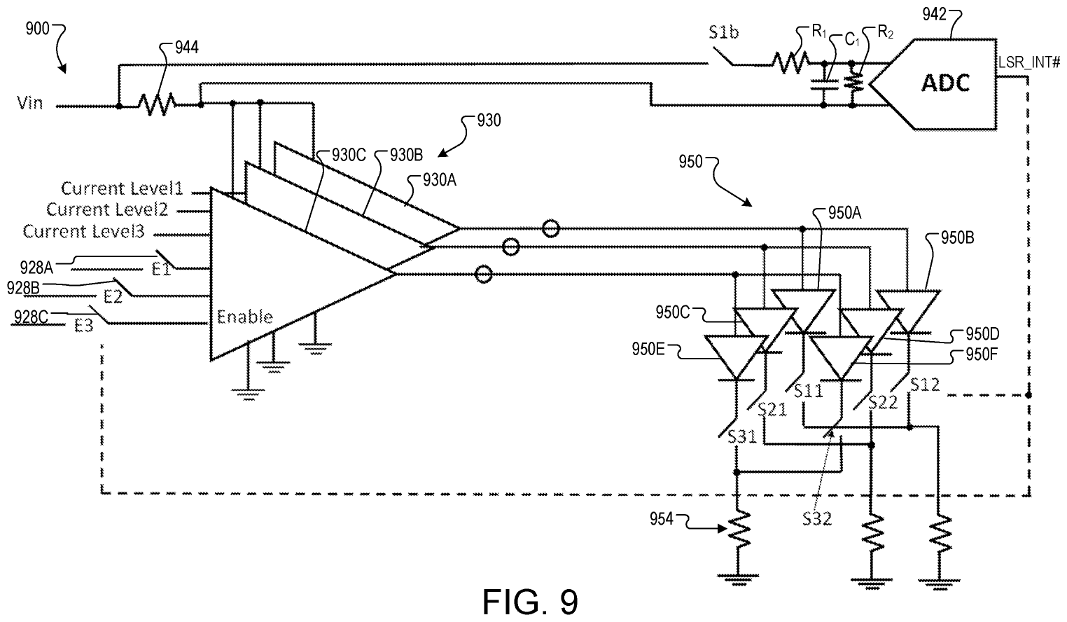

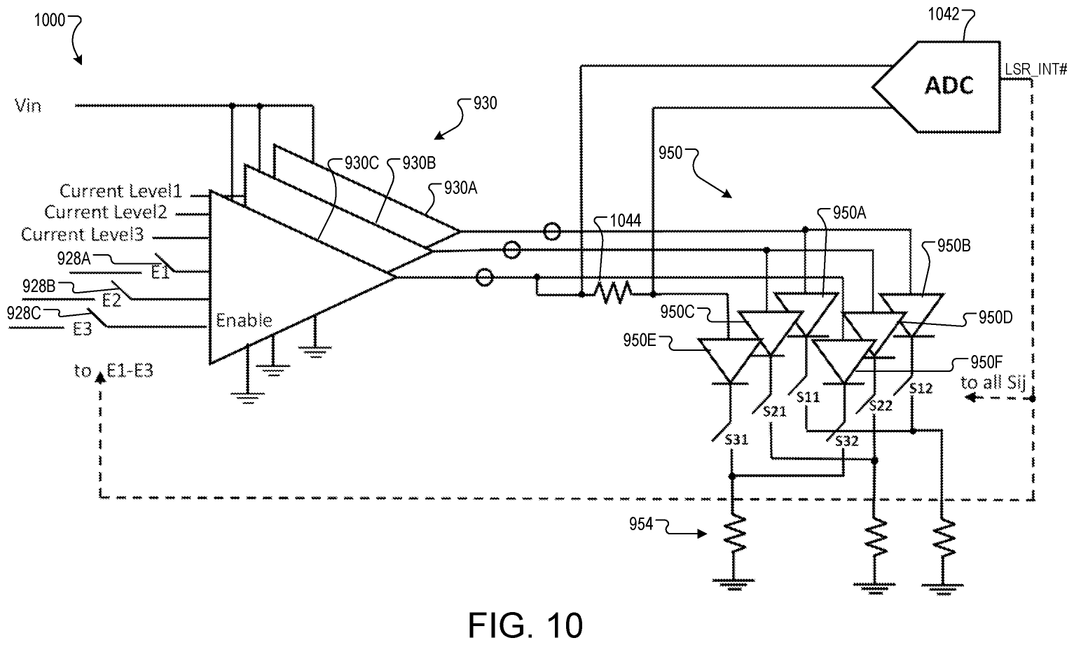

FIG. 9 is a schematic diagram of a driver circuit 900 with safety circuitry that senses current going into multiple current drivers that drive sets of laser diodes, in accordance with some applications of the present disclosure. In the embodiment of FIG. 9, the driver circuit 900 includes a set of drivers 930, each configured to drive a laser diode of a set of laser diodes 950. Each driver of the set of drivers 930 receives a current level signal and is coupled to an enable switch. For example, a first current driver 930A receives a first current level (1) and is coupled to a first enable switch 928A, a second current driver 930B receives a second current level (2) and is coupled to a second enable switch 928B, and a third current driver 930C receives a third current level (3) and is coupled to a third enable switch 928C.

In various embodiments, each driver circuit of the set of driver circuits 930 drives a pair of laser diodes. For example, the first current driver 930A can drive a first laser diode 950A and a second laser diode 950B, the second current driver 930B can drive a third laser diode 950C and a fourth laser diode 950D, and the third current driver 930C can drive a fifth laser diode 950E and a sixth laser diode 950F. In embodiments, the set of laser diodes 950 are blue laser diodes. In other embodiments, the set of laser diodes 950 are green laser diodes.

In these embodiments, the driver circuit 900 includes a set of load switches coupled to a respective laser diode of the set of laser diodes 950. For example, in some embodiments, a first load switch S11 is coupled to the first laser diode 950A, a second load switch S12 is coupled to the second laser diode 950B, a third load switch S21 is coupled to the third laser diode 950C, a fourth load switch S22 is coupled to the fourth laser diode 950D, a fifth load switch S31 is coupled to the fifth laser diode 950E, and a sixth load switch S32 is coupled to the sixth laser diode 950F. The driver circuit 900 may also include feedback resistors 954, each that feeds back a current to a current driver of the set of current drivers 930 that flows through a current loop of the driver circuit 900 defined by any given pair of the set of laser diodes 950. In these embodiments, the control logic, in addition to send enable signals to the driver enable switches 928A-928C, may also send load enable signals to turn ON/OFF the load switches S11-S32 according to programmed sequence for turning ON (or OFF) coupled light projectors.

In these embodiments, the set of current drivers 930 receives an input voltage from a single input voltage source (Vin), in line with which is positioned a sense resistor 944. An analog-to-digital converter (ADC) or ADC 942 is coupled to the sense resistor 944. In these embodiments, the ADC 942 is configured to monitor, through the sense resistor 944, an input current to the set of drivers 930, compare the input current to a threshold current, and, in response to the input current satisfying the threshold current, activate an alert interrupt signal (LSR_INT #) that causes each enable switch 928A, 928B, and 928C to be turned off. In some embodiments, the alert interrupt signal (LSR_INT #) optionally also causes each load switch to be turned off.

In at least some embodiments, the safety circuitry of the driver circuit 900 further includes the resistor R₁ coupled inline to an upper lead line coupled to the ADC 942, the capacitor C₁ coupled across the lead lines from the ADC 942, a resistor R₂ coupled in parallel to the capacitor C₁, and the ADC switch S1b coupled inline on the upper lead line between the ADC 942 and the sense resistor 944. The ADC switch S1b may select the source of the measurement taken by the safety circuitry, including the ADC 842, coupled to the sense resistor 844, and thus synchronize sensing the current when certain types of the laser diodes are activated. The resistors R₁ and R₂ and the capacitor C₁ may be employed to estimate the current passing through one of the set of laser diodes 950, depending on which laser diode is turned on.

In various embodiments, the control logic 320 is coupled to the ADC switch Sb1, to the enable switches 928A-928C, and to the set of load switches S11-S32. In some embodiments, at least the first laser diode 950A, the second laser diode 950C, and the fifth laser diode 950E are blue laser diodes. In these embodiments, the control logic 320 causes the ADC switch Sb1 and the load switches S11, S21, and S31 to turn on and cause the enable switches 928A, 928B, and 928C to turn on. In embodiments, the alert interrupt signal (LSR_INT #) thus causes at least the enable switches 928A, 928B, and 928C to turn off and causes the laser diodes 950A, 950C, and 950E to turn off.

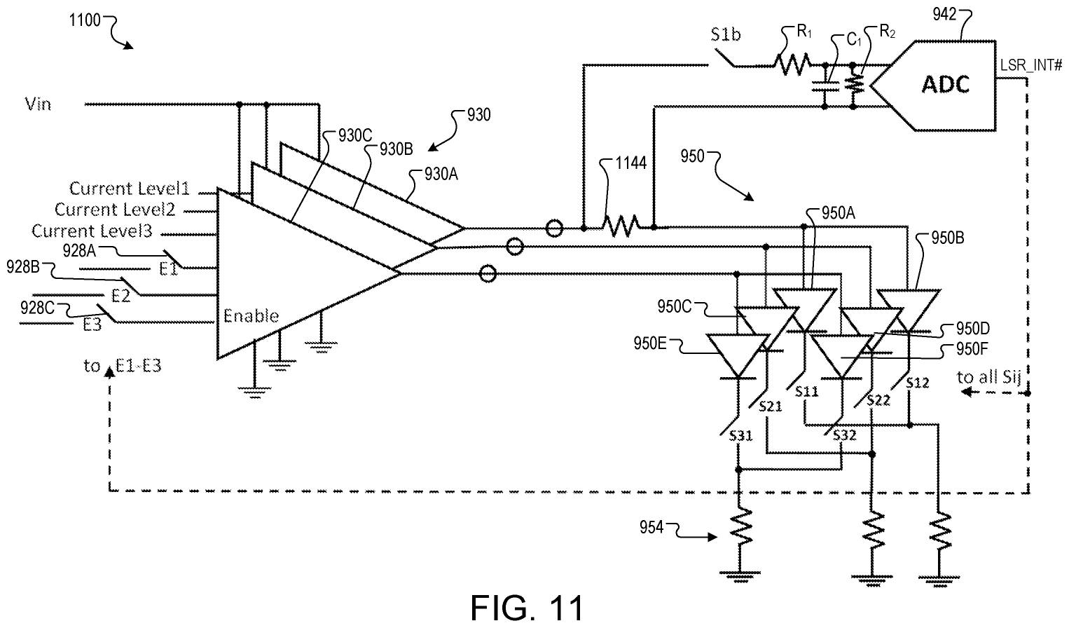

FIG. 10 is a schematic diagram of a driver circuit 1000 with safety circuitry that sense an output current of a current driver when that current driver is driving a particular laser diode of multiple laser diodes, in accordance with some applications of the present disclosure. As a modified extension to the embodiments of FIG. 9, the driver circuit 1000 instead includes a sense resistor 1044 coupled inline within an output line of each respective driver of the set of drivers 930. The sense resistor 1044 is illustrated as only being coupled to the third current driver 930C. Although only one sense resistor 1044 is illustrated for purposes of clarity of illustration, a sense resistor may be positioned directly in front of or behind and in series with a respective laser diode of the set of laser diodes 950. An ADC 1042 may also be coupled to the sense resistor 1044 to detect current passing through the output line through a particular laser diode, e.g., in this case, through the fifth laser diode 950E. Thus, an ADC 1042 may be replicated as coupled to each sense resistors to be able to directly sense a current passing through each respective laser diode of the set of laser diodes 950.

In these embodiments, the third current driver 930C is to drive at least two laser diodes of the set of laser diodes, e.g., laser diodes 950E and 950F, of which at least the third laser diode 950E may be a blue laser diode. The sense resistor 1044 is coupled in series only with the third laser diode 950E. In embodiments, the control logic 320 is coupled to the fifth load switch S31 and to the third enable switch S31 of the enable switches. In embodiments, to activate the third laser diode 950E, the control logic 320 causes the third load switch S31 to turn on and the third enable switch E3 to turn on.

In these embodiments, the ADC 1042 senses current passing through the fifth laser diode 950E that is coupled to a fifth load switch S31. In embodiments, the ADC 1042 monitors, through the sense resistor 1044, an output current from a driver of the set of drivers, e.g., the third current driver 930C in this case. The ADC 1042 may further be configured to compare the output current to a threshold current and, in response to the output current satisfying the threshold current, activate an alert interrupt signal (LSR_INT #) that causes each enable switch 928A-928C to be turned off. In these embodiments, the alert input signal also causes the load switches S11-S32 to be turned off.

Due to the duplication of hardware, in various embodiments, the driver circuit 1000 includes a second ADC (not illustrated) coupled to a second sense resistor (not illustrated) of the sense resistors. The second sense resistor may be coupled to a different laser diode of the set of laser diodes 950. For purposes of explanation, assume the second sense resistor is coupled to the second current driver 930B and, of the set of laser diodes 950, only to the third laser diode 950C. In embodiments, the second ADC is configured to monitor, through the second sense resistor, a second output current from a second driver of the set of drivers. The second ADC is further configured to compare the second output current to the threshold current and, in response to the second output current satisfying the threshold current, activate the alert interrupt signal.

Due to the duplication of hardware, in various embodiments, the driver circuit 1000 includes a third ADC (not illustrated) coupled to a third sense resistor (not illustrated) of the sense resistors. The third sense resistor may be coupled to a different laser diode of the set of laser diodes 950. For purposes of explanation, assume the third sense resistor is coupled to the first current driver 930A and, of the set of laser diodes 950, only to the first laser diode 950A. In embodiments, the third ADC is configured to monitor, through the third sense resistor, a third output current from a first driver of the set of drivers. The third ADC is further configured to compare the third output current to the threshold current and, in response to the third output current satisfying the threshold current, activate the alert interrupt signal.

FIG. 11 is a schematic diagram of a driver circuit 1100 with safety circuitry that senses an output current of a current driver that drives more than one laser diode, in accordance with some applications of the present disclosure. As a modified extension to the embodiments of FIG. 9, the driver circuit 1000 instead includes a sense resistor 1144 coupled inline within an output line of each respective driver of the set of drivers 930. Thus, in these embodiments, the first current driver 930A is coupled to and configured to drive the first laser diode 950A and the second laser diode 950B. In some embodiments, at least the first laser diode 950A is a blue laser diode. In these embodiments, the sense resistor 1144 is therefore coupled to both the first laser diode 950A and the second laser diode 950B.

Where only one of the laser diodes (e.g., the first laser diode 950A) may need to be monitored, the ADC 942 is selectively coupled to the sense resistor 1144 via the ADC switch S1b, e.g., so that when current flows through the second laser diode 950B, the current monitoring of the ADC 942 is optionally disengaged. The resistors R₁, R₂, and capacitor C₁ of the safety circuitry was described with reference to FIG. 9, although the sense resistor 944 in FIG. 9 is instead coupled to the input voltage line of the set of current drivers 930. In various embodiments, a second sense resistor is coupled to the output line of the second current driver 930B and a third sense resistor is coupled to the output line of the third current driver 930C. In such embodiments, the ADC 942 and associated safety circuitry is replicated to be also coupled to the second sense resistor and the third sense resistor, respectively. This replicated hardware is not described for purposes of brevity.

In various embodiments, the control logic 320 is coupled to the ADC switch Sb1, to the first enable switch E1, and to the first load switch S11. In embodiments, to activate the first laser diode 950A (which can be a first blue laser diode, for example), the control logic is configured to cause the ADC switch S1b and the first load switch S11 to turn on. The control logic 320 may then cause the first enable switch E1 to turn on to fully power the first laser diode 950A. In embodiments, the control logic, in response to receipt of the alert interrupt signal, causes the first enable switch E1 to turn off and causes the first load switch S11 to turn off, e.g., optionally in that order.

FIG. 12 is a simplified schematic diagram of a driver circuit 1200 illustrating different exemplary locations where a sense resistor 1244 can be positioned to which is coupled safety circuitry as discussed herein, in accordance with some applications of the present disclosure, e.g., to include an ADC (or other circuitry) and other passive components. As illustrated, the driver circuit 1200 is similar to the driver circuit 500 that was already discussed. In the driver circuit 1200, the sense resistor 1244 is illustrated as being positional at any locations of Location A, Location B, and Location C. Each of the driver circuit 500 (FIG. 5), the driver intraoral scanner 600 (FIG. 6), the driver circuit 800 (FIG. 8), the driver circuit 1000 (FIG. 10), and the driver circuit 1100 (FIG. 11) discussed herein can likewise be so modified so the various sense resistors can be variably positioned throughout the current driver loops that are illustrated.

In various embodiments, the ADC 542, the ADC 842, the ADC 942, the ADC 1042, and other ADCs referred to but not specifically illustrated (e.g., with reference to duplicated hardware) are replaced with circuitry 1242 (e.g., sense circuitry) that is configured to sense current through a coupled sense resistor (e.g., sense resistor 1244) and to compare the sensed current to a threshold current. In at least some embodiments, this circuitry 1242 includes an operational amplifier 1262 (or other amplifier), a comparator 1266, and a digital-to-analog converter (DAC) 1268 or other source of a reference voltage (Vref) for the comparator 1266. For example, the processor 306 or the control logic 320 (FIG. 3) may program a digital value (which may optionally be stored in a register or other memory) that is provided to the DAC 1268 that cause the DAC 1268 to generate the reference voltage (Vref). In this embodiment, the operational amplifier 1262 amplifies the sensed current to provide an adequate voltage signal for purposes of being compared by the comparator 1266. The comparator 1266 then compares the amplified sensed voltage with the reference voltage and outputs the laser alert signal (LSR_INT #) in response to a triggered output of the comparator 1266. Other implementations of the circuitry 1242 that varies from an ADC or employs a comparator 1266 would be apparent to those skilled in the art. For example, in some embodiments, a set/reset flip-flip (not illustrated) is coupled to an output of the comparator 1266 that is set upon an asserted output of the comparator 1266, which thus holds the laser alert signal until it is reset, e.g., by the processor 306. Additional circuitry is envisioned.

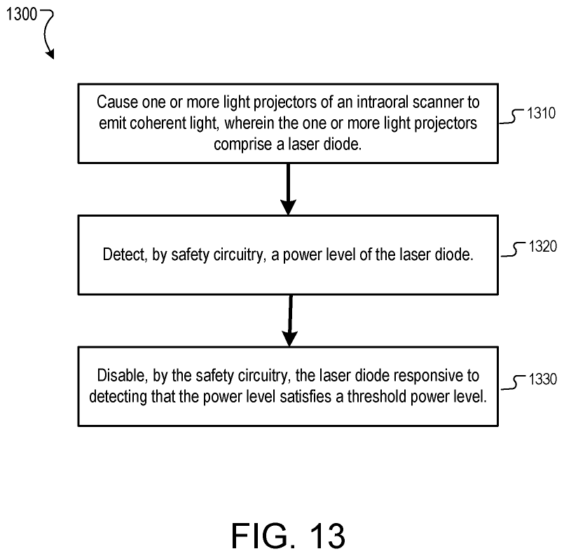

FIG. 13 is a flow chart of a method 1300 for monitoring light projectors of an intraoral scanner and disabling a laser diode in response to detecting current passing through the laser diode exceeds a threshold current, in accordance with some applications of the present disclosure. The method 1300 can be performed by processing logic that can include hardware (e.g., processing device, circuitry, dedicated logic, programmable logic, microcode, hardware of a device, integrated circuit, etc.), software (e.g., instructions run or executed on a processing device, to include firmware), or a combination thereof. In some embodiments, the method 1300 is performed by the control logic 320 or by a combination of the control logic 320 and the processor 306 of FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1310, the processing logic causes one or more light projectors of an intraoral scanner to emit coherent light, wherein the one or more light projectors include a laser diode.

At operation 1320, safety circuitry detects a power level of the laser diode.

At operation 1330, safety circuitry disables the laser diode responsive to detecting that the power level satisfies a threshold power level. The safety circuitry may include an ADC coupled to and for sensing the current passing through a sense resistor that is connected in series with the laser diode.

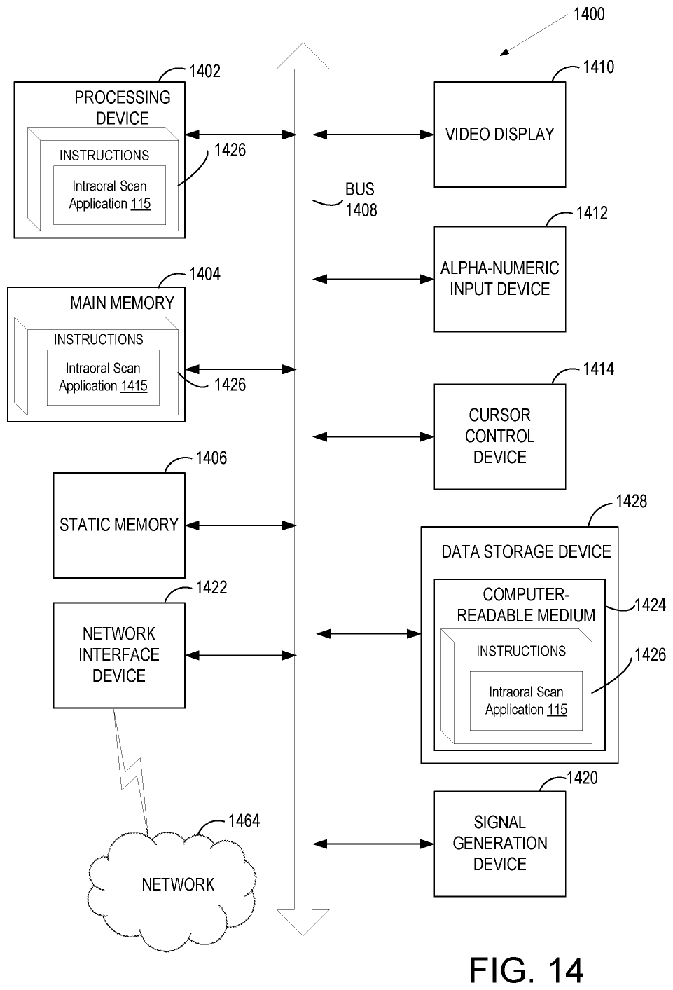

FIG. 14 illustrates a diagrammatic representation of a machine in the example form of a computing device 1400 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The computing device 1400 may correspond, for example, to computing device 105 and/or computing device 106 of FIG. 1. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 1400 includes a processing device 1402, a main memory 1404 (e.g., read-only memory (ROM), flash memory, dynamic random access memory (DRAM) such as synchronous DRAM (SDRAM), etc.), a static memory 1406 (e.g., flash memory, static random access memory (SRAM), etc.), and a secondary memory (e.g., a data storage device 1428), which communicate with each other via a bus 1408.

Processing device 1402 represents one or more general-purpose processors such as a microprocessor, central processing unit, or the like. More particularly, the processing device 1402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. Processing device 1402 is configured to execute the processing logic (instructions 1426) for performing operations and steps discussed herein.

The computing device 1400 may further include a network interface device 1422 for communicating with a network 1464. The computing device 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse), and a signal generation device 1420 (e.g., a speaker).

The data storage device 1428 may include a machine-readable storage medium (or more specifically a non-transitory computer-readable storage medium) 1424 on which is stored one or more sets of instructions 1426 embodying any one or more of the methodologies or functions described herein, such as instructions for intraoral scan application 1415, which may correspond to intraoral scan application 115 of FIG. 1. A non-transitory storage medium refers to a storage medium other than a carrier wave. The instructions 1426 may also reside, completely or at least partially, within the main memory 1404 and/or within the processing device 1402 during execution thereof by the computing device 1400, the main memory 1404 and the processing device 1402 also constituting computer-readable storage media.

The computer-readable storage medium 1424 may also be used to store dental modeling logic, which may include one or more machine learning modules, and which may perform the operations described herein above. The computer readable storage medium 1424 may also store a software library containing methods for the intraoral scan application 115. While the computer-readable storage medium 1424 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium other than a carrier wave that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. An intraoral scanner comprising:
one or more light projectors to emit coherent light, the one or more light projectors comprising a laser diode; and
safety circuitry coupled to the laser diode, the safety circuitry configured to:
detect a power level of the laser diode; and
disable the laser diode responsive to detecting that the power level satisfies a threshold power level.

2. The intraoral scanner of claim 1, wherein the laser diode is one of a set of laser diodes, further comprising a set of drivers, each configured to drive a respective laser diode of the set of laser diodes, wherein each driver of the set of drivers is to receive a current level signal and is coupled to an enable switch.

3. The intraoral scanner of claim 2, wherein the safety circuitry comprises:
a sense resistor coupled within an input current line of the set of drivers; and
sense circuitry coupled to the sense resistor, the sense circuitry to:
monitor, through the sense resistor, an input current to the set of drivers;
compare the input current to a threshold current; and
in response to the input current satisfying the threshold current, activate an alert interrupt signal that causes each enable switch to be turned off.

4. The intraoral scanner of claim 1, further comprising a driver coupled to the laser diode to drive the laser diode, wherein the driver receives a current level and is coupled to an enable switch.

5. The intraoral scanner of claim 4, wherein the safety circuitry comprises:
a sense resistor coupled inline within an output line of the driver; and
sense circuitry coupled to the sense resistor, the sense circuitry to:
monitor, through the sense resistor, a first output current from the driver;
compare the first output current to a threshold current; and
in response to the output current satisfying the threshold current, activate an alert interrupt signal that causes the enable switch to be turned off.

6. A method comprising:
causing one or more light projectors of an intraoral scanner to emit coherent light, wherein the one or more light projectors comprise a laser diode;
detecting, by safety circuitry, a power level of the laser diode; and
disabling, by the safety circuitry, the laser diode responsive to detecting that the power level satisfies a threshold power level.

7. The method of claim 6, wherein the detecting comprises comparing a current through the laser diode with a threshold current.

8. The method of claim 7, wherein the disabling comprises disabling at least one of:
an enable switch coupled to a driver of the laser diode; or
a load switch coupled to the laser diode.

9. An intraoral scanner comprising:
a set of drivers, each configured to drive a laser diode of a set of laser diodes, wherein each driver of the set of drivers is to receive a current level signal and is coupled to an enable switch;
a sense resistor coupled within an input current line of the set of drivers; and
circuitry coupled to the sense resistor, the circuitry to:
monitor, through the sense resistor, an input current to the set of drivers;
compare the input current to a threshold current; and
in response to the input current satisfying the threshold current, activate an alert interrupt signal that causes each enable switch to be turned off.

10. The intraoral scanner of claim 9, wherein the set of drivers comprise at least a first driver, a second driver, and a third driver, wherein the set of laser diodes comprise a first blue laser diode being driven by the first driver, a second blue laser diode being driven by the second driver, and a third blue laser diode being driven by the third driver, and wherein the enable switches comprise a first enable switch coupled to the first driver, a second enable switch coupled to the second driver, and a third enable switch coupled to the third driver, the intraoral scanner further comprising:
a first switch coupled between the circuitry and the sense resistor;
a first load switch coupled to the first blue laser diode;
a second load switch coupled to the second blue laser diode;
a third load switch coupled to the third blue laser diode; and
control logic coupled to the first switch, to the first, second, and third enable switches, and to the first, second, and third load switches, wherein, to activate the first, second, and third blue laser diodes, the control logic is to:
cause the first switch and the first, second, and third load switches to turn on; and
cause the first, second, and third enable switches to turn on.

11. The intraoral scanner of claim 10, wherein the alert interrupt signal is to cause the first, second, and third enable switches to turn off and cause the first, second, and third load switches to turn off.

12. The intraoral scanner of claim 10, further comprising:
a processor coupled to the circuitry;
a field effect transistor (FET) having a gate coupled to the processor via an input/output (I/O) expander circuit; and
a diode coupled between a drain of the FET and: i) the first enable switch; and ii) the first, second, and third load switches; and
wherein the processor is to, responsive to receiving the alert interrupt signal from the circuitry, cause the FET to turn on, forcing the first, second, and third enable switches and the first, second, and third load switches to continue to receive the alert interrupt signal.

13. The intraoral scanner of claim 10, wherein the control logic is configured to periodically perform a built-in self-test, which performs operations comprising:
causing the first, second, and third enable switches to be turned off;
causing the first, second, and third load switches to be turned off while confirming the input current is low; and
causing the first, second, and third load switches to be turned on while confirming the input current remains low.

14. The intraoral scanner of claim 9, wherein the circuitry is an analog-to-digital converter (ADC), further comprising:
a register located within the ADC, wherein the ADC is to write an alert flag to the register in response to activating the alert interrupt signal; and
a processor coupled to the ADC, the processor to:
determine the ADC has activated the alert interrupt signal by reading the alert flag from the register; and
enter a fatal error state to inactivate the intraoral scanner.

15. An intraoral scanner comprising:
a set of drivers, each configured to drive a laser diode of a set of laser diodes, wherein each driver of the set of drivers is to receive a current level signal and is coupled to an enable switch;
a sense resistor coupled inline within an output line of each respective driver of the set of drivers; and
circuitry coupled to a first sense resistor of the sense resistors, the first sense resistor being coupled to a first laser diode of the set of laser diodes, wherein the circuitry is to:
monitor, through the first sense resistor, a first output current from a first driver of the set of drivers;
compare the first output current to a threshold current; and
in response to the first output current satisfying the threshold current, activate an alert interrupt signal that causes each enable switch to be turned off.

16. The intraoral scanner of claim 15, wherein the first driver is to drive at least two laser diodes of the set of laser diodes, of which the first laser diode is a blue laser diode, wherein the first sense resistor is coupled in series only with the first laser diode, wherein the intraoral scanner further comprises:
a first load switch also coupled to the first laser diode; and
control logic coupled to the first load switch and to a first enable switch of the enable switches, wherein, to activate the first laser diode, the control logic is to cause the first load switch to turn on and the first enable switch to turn on.

17. The intraoral scanner of claim 16, wherein the alert interrupt signal is to cause the first enable switch to turn off and cause the first load switch to turn off.

18. The intraoral scanner of claim 16, further comprising:
a processor coupled to the circuitry;
a field effect transistor (FET) having a gate coupled to the processor via an input/output (I/O) expander circuit; and
a diode coupled between a drain of the FET and: i) the first enable switch; and ii) the first load switch; and
wherein the processor is to, responsive to receiving the alert interrupt signal from the circuitry, cause the FET to turn on, forcing the first enable switch and the first load switch to continue to receive the alert interrupt signal.

19. The intraoral scanner of claim 16, wherein the control logic is configured to periodically perform a built-in self-test, comprising:
causing the first load switch to be turned off;
causing the first enable switch to be turned off while confirming the output current is low; and
causing the first enable switch to be turned on while confirming the output current remains low.

20. The intraoral scanner of claim 15, wherein the circuitry is a first analog-to-digital converter (ADC), further comprising:
a register located within the first ADC, the first ADC to write an alert flag to the register in response to activating the interrupt alert signal; and
a processor coupled to the first ADC, the processor to:
determine the first ADC has activated the interrupt alert signal by reading the alert flag from the register; and
enter a fatal error state to inactivate the intraoral scanner.

21. The intraoral scanner of claim 15, further comprising:
second circuitry coupled to a second sense resistor of the sense resistors, the second sense resistor being coupled to a second laser diode of the set of laser diodes, wherein the second circuitry is to:
monitor, through the second sense resistor, a second output current from a second driver of the set of drivers;
compare the second output current to the threshold current; and
in response to the second output current satisfying the threshold current, activate the alert interrupt signal.

22. The intraoral scanner of claim 15, wherein the first driver is to drive at least two laser diodes of the set of laser diodes, of which the first laser diode is a first blue laser diode, and wherein the enable switches comprise at least a first enable switch coupled to the first driver, the intraoral scanner further comprising:
a first switch coupled between the circuitry and the first sense resistor;
a first load switch coupled to the first blue laser diode; and
control logic coupled to the first switch, to the first enable switch, and to the first load switch, wherein, to activate the first blue laser diode, the control logic is to:
cause the first switch and the first load switch to turn on; and
cause the first enable switch to turn on.

23. The intraoral scanner of claim 22, wherein the control logic is further to, in response to receipt of the alert interrupt signal, cause the first enable switch to turn off and cause the first load switch to turn off.

24. The intraoral scanner of claim 22, further comprising:
a processor coupled to the circuitry;
a field effect transistor (FET) having a gate coupled to the processor via an input/output (I/O) expander circuit; and
a diode coupled between a drain of the FET and: i) the first enable switch; and ii) the first load switch; and
wherein the processor is to, responsive to receiving the alert interrupt signal from the circuitry, cause the FET to turn on, forcing the first enable switch and the first load switch to continue to receive the alert interrupt signal.

25. The intraoral scanner of claim 22, wherein the control logic is configured to periodically perform a built-in self-test, comprising:
causing the first load switch to be turned off;
causing the first enable switch to be turned off while confirming the output current is low; and
causing the first enable switch to be turned on while confirming the output current remains low.

26. A method comprising:
sequentially activating, using control logic of an intraoral scanner, a set of light projectors in connection with timed capture of image frames of one or more cameras of the intraoral scanner;
accessing, by the control logic, pulse length values that limit durations of pulses of one or more light projectors of the set of light projectors;
tracking, by the control logic using one or more counters, pulse lengths of the one or more light projectors during operational scanning; and
responsive to detecting the pulse length of a pulse from a light projector of the set of light projectors satisfies a corresponding pulse length value, causing the set of light projectors to be turned off.

27. The method of claim 26, further comprising, responsive to detecting the pulse length of the pulse satisfying the corresponding pulse length value, triggering a processor of the intraoral scanner to enter a fatal error state that causes the intraoral scanner to become deactivated.

28. The method of claim 26, wherein the set of light projectors comprises one or more blue laser diodes, the method further comprising setting an overdrive signal routed to one or more drivers that are operatively coupled to the one or more blue laser diodes, wherein the overdrive signal causes the one or more drivers to operate in a high current state.

29. The method of claim 26, wherein the set of light projectors comprises one or more blue laser diodes, the method further comprising setting a current drive signal to set a current level at which one or more of drivers will drive the one or more blue laser diodes.

30. The method of claim 26, wherein the set of light projectors include blue laser diodes, green laser diodes, white light-emitting diodes (LEDs), and near-infrared LEDs, the method further comprising programming the control logic with:
a sequence of activation of the set of lights; and
a different pulse length value for each type of light projector of the set of light projectors.
